(19) United States
(12) Patent Application Publication
(10) Pub. No.: US 2014/0221023 A1
(43) Pub. Date: Aug. 7, 2014

(54) SERVER-INITIATED PAGING CYCLES

(71) Applicant: Qualcomm Incorporated, San Diego, CA (US)

(72) Inventors: Mark MAGGENTI, Del Mar, CA (US); Arvind SANTHANAM, San Diego, CA (US)

(73) Assignee: Qualcomm Incorporated, San Diego, CA (US)

(21) Appl. No.: 14/171,549

(22) Filed: Feb. 3, 2014

Related U.S. Application Data
(60) Provisional application No. 61/760,803, filed on Feb. 5, 2013.

(51) Int. Cl. H04W 68/02

(52) U.S. Cl. CPC H04W 68/02
USPC 455/458

(57) ABSTRACT

In an embodiment, a server registers a client application installed on a user equipment (UE), and evaluates one or more paging cycle criteria for the registered client application. The server determines to establish a target paging cycle used for downlink paging of the UE by a network component (e.g., an access network component or a core network component) of a serving network based on the evaluation, and the server transmits, to the network component, a request for the network component to transition the given UE to the target paging cycle based on the determination. The network component receives the request and assigns the target paging cycle to the UE as requested.

### CLAIM OF PRIORITY UNDER 35 U.S.C. §119

The present application for patent claims priority to Provisional Application No. 61/760,803, entitled “SERVER-INITIATED PAGING CYCLES”, filed Feb. 5, 2013, by the same inventors as the subject application, assigned to the assignee hereof and hereby expressly incorporated by reference herein in its entirety.

### BACKGROUND OF THE INVENTION

1. Field of the Invention

Embodiments of the invention relate to server-initiated paging cycles for user equipments (UEs) in a wireless communications system.

2. Description of the Related Art

Wireless communication systems have developed through various generations, including a first-generation analog wireless phone service (1G), a second-generation (2G) digital wireless phone service (including interim 2.5G and 2.75G networks) and third-generation (3G) and fourth-generation (4G) high speed data/Internet-capable wireless services. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

More recently, Long Term Evolution (LTE) has been developed as a wireless communications protocol for wireless communication of high-speed data for mobile phones and other data terminals. LTE is based on GSM, and includes contributions from various GSM-related protocols such as Enhanced Data rates for GSM Evolution (EDGE), and Universal Mobile Telecommunications System (UMTS) protocols such as High-Speed Packet Access (HSPA).

### SUMMARY

In an embodiment, a server registers a client application installed on a user equipment (UE), and evaluates one or more paging cycle criteria for the registered client application. The server determines to establish a target paging cycle used for downlink paging of the UE by a network component (e.g., an access network component or a core network component) of a serving network based on the evaluation, and the server transmits, to the network component, a request for the network component to transition the given UE to the target paging cycle based on the determination. The network component receives the request and assigns the target paging cycle to the UE as requested.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 illustrates a high-level system architecture of a wireless communications system in accordance with an embodiment of the invention.

FIG. 2A illustrates an example configuration of a radio access network (RAN) and a packet-switched portion of a core network for a 1x EV-DO network in accordance with an embodiment of the invention.

FIG. 2B illustrates an example configuration of the RAN and a packet-switched portion of a General Packet Radio Service (GPRS) core network within a 3G UMTS W-CDMA system in accordance with an embodiment of the invention.

FIG. 2C illustrates another example configuration of the RAN and a packet-switched portion of a GPRS core network within a 3G UMTS W-CDMA system in accordance with an embodiment of the invention.

FIG. 2D illustrates an example configuration of the RAN and a packet-switched portion of the core network that is based on an Evolved Packet System (EPS) or Long Term Evolution (LTE) network in accordance with an embodiment of the invention.

FIG. 2E illustrates an example configuration of an enhanced High Rate Packet Data (HRPD) RAN connected to an EPS or LTE network and also a packet-switched portion of an HRPD core network in accordance with an embodiment of the invention.

FIG. 3 illustrates examples of user equipments (UEs) in accordance with embodiments of the invention.

FIG. 4 illustrates a communication device that includes logic configured to perform functionality in accordance with an embodiment of the invention.

FIG. 5 illustrates a server in accordance with an embodiment of the invention.

FIG. 6 illustrates a conventional UE-initiated paging cycle adjustment procedure.

FIG. 7 illustrates a conventional RAN-initiated paging cycle adjustment procedure.

FIG. 8 illustrates a server-initiated paging cycle adjustment procedure in accordance with an embodiment of the invention.

FIG. 9 illustrates an example implementation of the process of FIG. 8 in accordance with an embodiment of the invention.

FIGS. 10A-10B collectively illustrate an example implementation of the process of FIG. 8 in accordance with another embodiment of the invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

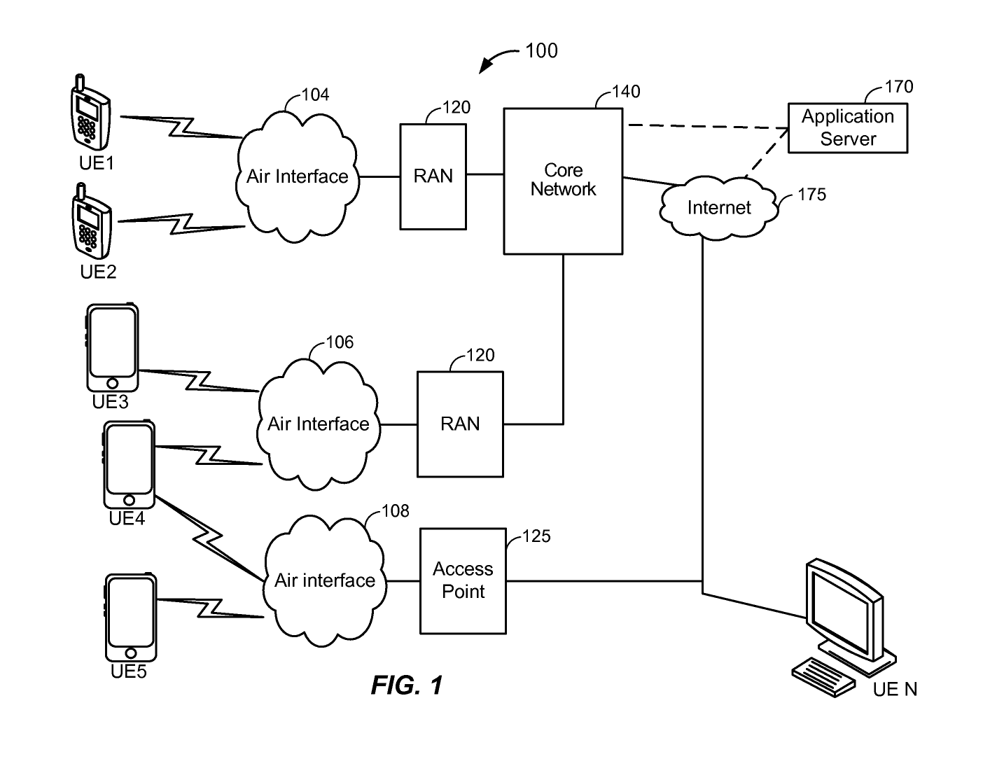

FIG. 1 illustrates a high-level system architecture of a wireless communications system 100 in accordance with an embodiment of the invention. The wireless communications system 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UE N and UEs 1 . . . N via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, an application server 170 is shown as connected to the Internet 175, the core network 140, or both. The application server 170 can be implemented as a plurality of structurally separate servers, or alternately may correspond to a single server. As will be described below in more detail, the application server 170 is configured to support one or more communication services (e.g., Voice-over-Internet Protocol (VoIP) sessions, Push-to-Talk (PTT) sessions, group communication sessions, social networking services, etc.) for UEs that can connect to the application server 170 via the core network 140 and/or the Internet 175.

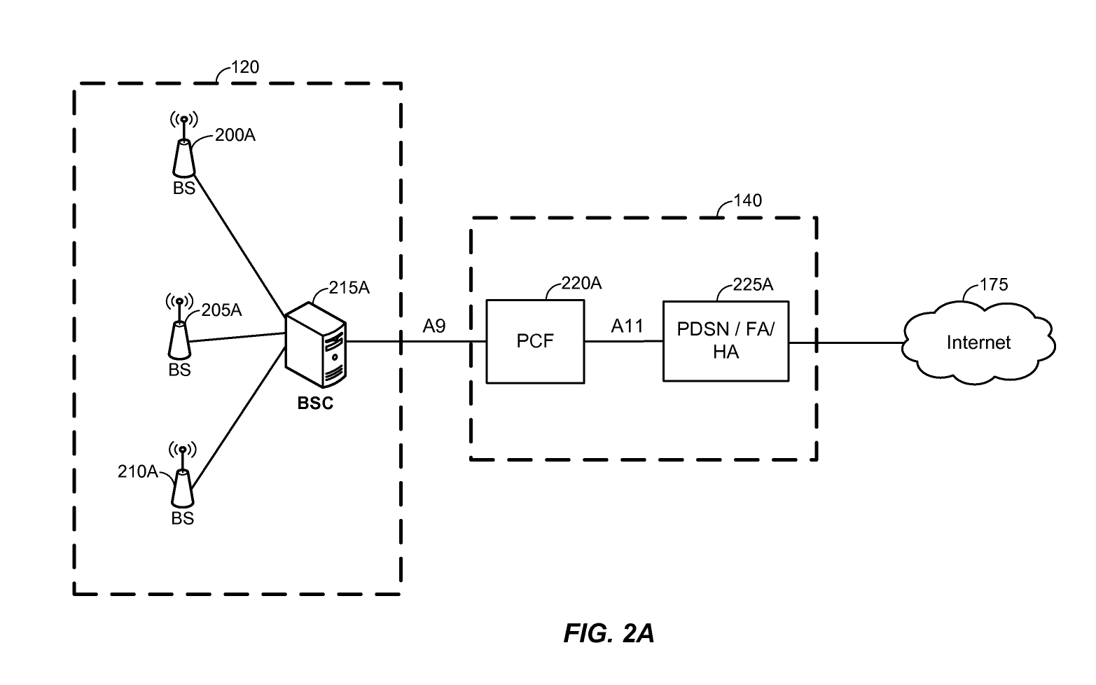

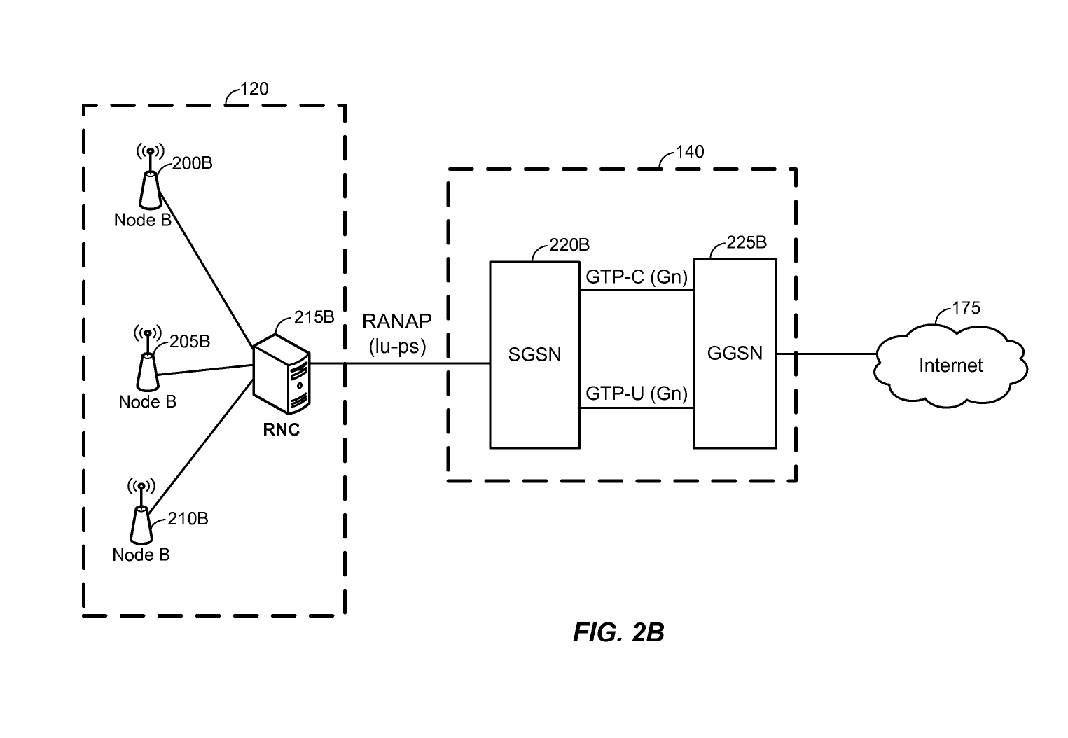

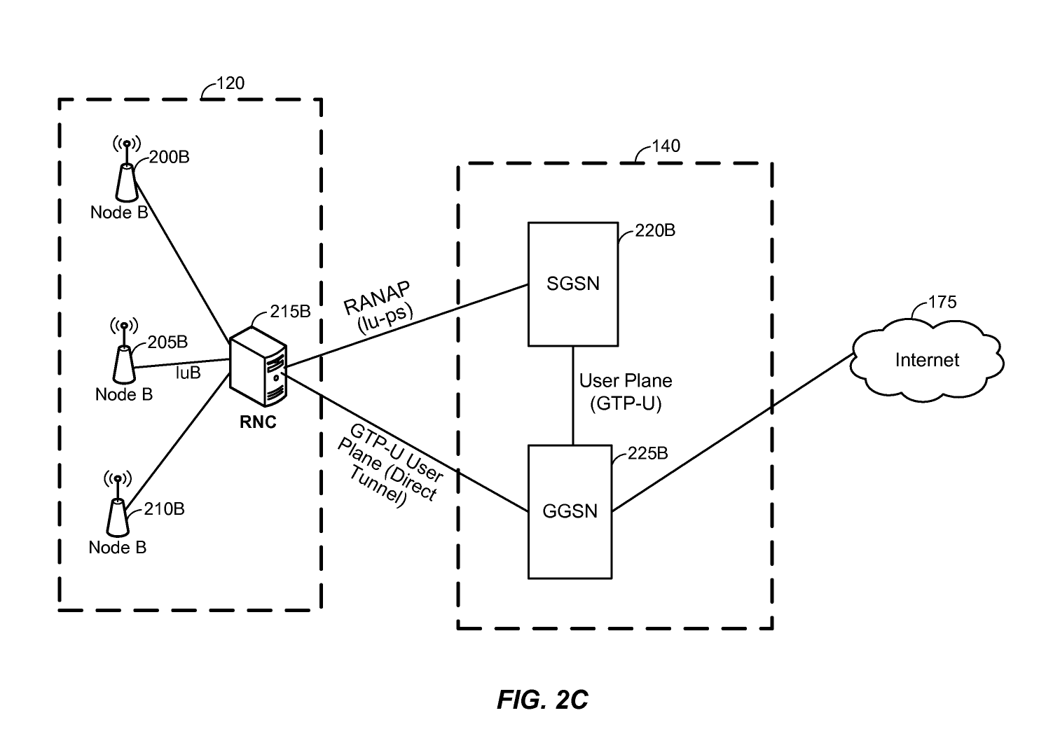

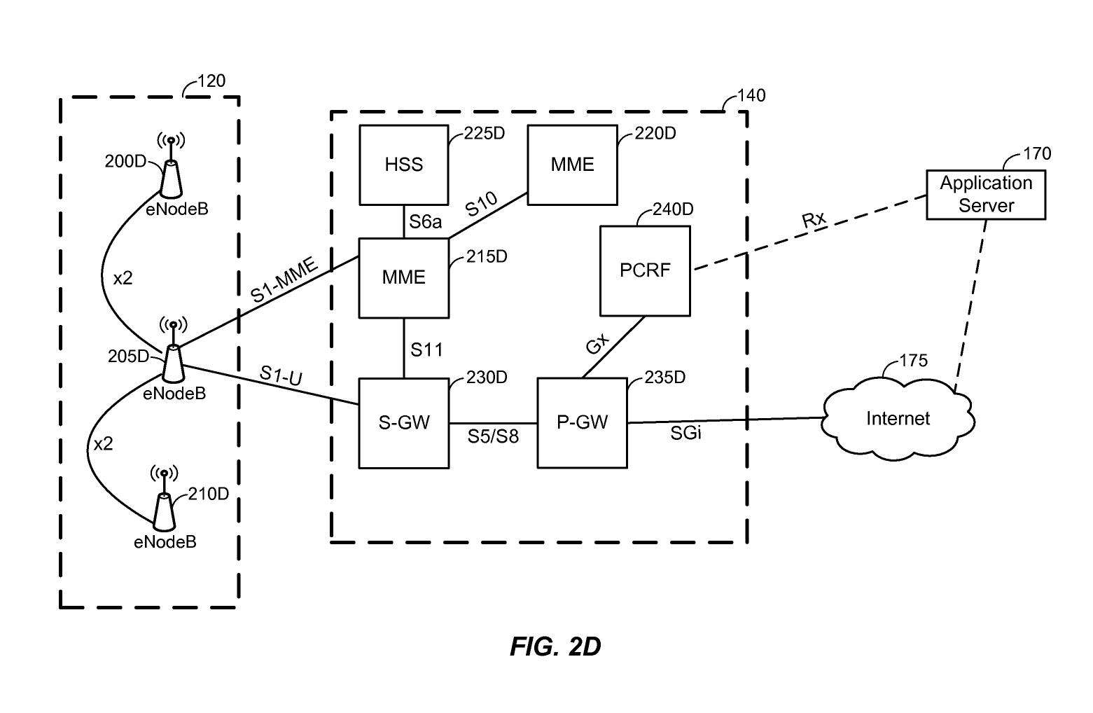

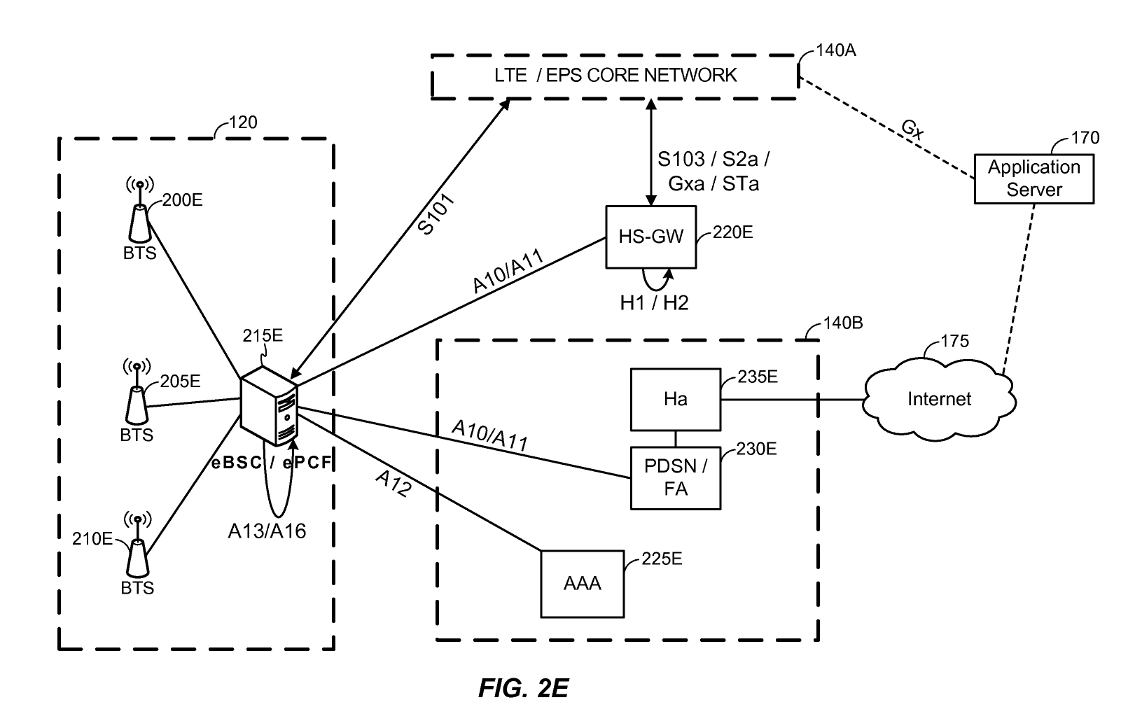

Examples of protocol-specific implementations for the RAN 120 and the core network 140 are provided below with respect to FIGS. 2A through 2D to help explain the wireless communications system 100 in more detail. In particular, the components of the RAN 120 and the core network 140 corresponds to components associated with supporting packet-switched (PS) communications, whereby legacy circuit-switched (CS) components may also be present in these networks, but any legacy CS-specific components are not shown explicitly in FIGS. 2A-2D.

FIG. 2A illustrates an example configuration of the RAN 120 and the core network 140 for packet-switched communications in a CDMA2000 1x Evolution-Data Optimized (EV-DO) network in accordance with an embodiment of the invention. Referring to FIG. 2A, the RAN 120 includes a plurality of base stations (BSs) 200A, 205A and 210A that are coupled to a base station controller (BSC) 215A over a wired backhaul interface. A group of BSs controlled by a single BSC is collectively referred to as a subnet. As will be appreciated by one of ordinary skill in the art, the RAN 120 can include multiple BSCs and subnets, and a single BSC is shown in FIG. 2A for the sake of convenience. The BSC 215A communicates with a packet control function (PCF) 220A within the core network 140 over an A9 connection. The PCF 220A performs certain processing functions for the BSC 215A related to packet data. The PCF 220A communicates with a Packet Data Serving Node (PDSN) 225A within the core network 140 over an A11 connection. The PDSN 225A has a variety of functions, including managing Point-to-Point (PPP) sessions, acting as a home agent (HA) and/or foreign agent (FA), and is similar in function to a Gateway General Packet Radio Service (GPRS) Support Node (GGSN) in GSM and UMTS networks (described below in more detail). The PDSN 225A connects the core network 140 to external IP networks, such as the Internet 175.

FIG. 2B illustrates an example configuration of the RAN 120 and a packet-switched portion of the core network 140 that is configured as a GPRS core network within a 3G UMTS W-CDMA system in accordance with an embodiment of the invention. Referring to FIG. 2B, the RAN 120 includes a plurality of Node Bs 200B, 205B and 210B that are coupled to a Radio Network Controller (RNC) 215B over a wired backhaul interface. Similar to 1x EV-DO networks, a group of Node Bs controlled by a single RNC is collectively referred to as a subnet. As will be appreciated by one of ordinary skill in the art, the RAN 120 can include multiple RNCs and subnets, and a single RNC is shown in FIG. 2B for the sake of convenience. The RNC 215B is responsible for signaling, establishing and tearing down bearer channels (i.e., data channels) between a Serving GRPS Support Node (SGSN) 220B in the core network 140 and UEs served by the RAN 120. If link layer encryption is enabled, the RNC 215B also encrypts the content before forwarding it to the RAN 120 for transmission over an air interface. The function of the RNC 215B is well-known in the art and will not be discussed further for the sake of brevity.

In FIG. 2B, the core network 140 includes the above-noted SGSN 220B (and potentially a number of other SGSNs as well) and a GGSN 225B. Generally, GPRS is a protocol used in GSM for routing IP packets. The GPRS core network (e.g., the GGSN 225B and one or more SGSNs 220B) is the centralized part of the GPRS system and also provides support for W-CDMA based 3G access networks. The GPRS core network is an integrated part of the GSM core network (i.e., the core network 140) that provides mobility management, session management and transport for IP packet services in GSM and W-CDMA networks.

The GPRS Tunneling Protocol (GTP) is the defining IP protocol of the GPRS core network. The GTP is the protocol which allows end users (e.g., UEs) of a GSM or W-CDMA network to move from place to place while continuing to connect to the Internet 175 as if from one location at the GGSN 225B. This is achieved by transferring the respective UE's data from the UE's current SGSN 220B to the GGSN 225B, which is handling the respective UE's session.

Three forms of GTP are used by the GPRS core network; namely, (i) GTP-U, (ii) GTP-C and (iii) GTP′ (GTP Prime). GTP-U is used for transfer of user data in separated tunnels for each packet data protocol (PDP) context. GTP-C is used for control signaling (e.g., setup and deletion of PDP contexts, verification of GSN reach-ability, updates or modifications such as when a subscriber moves from one SGSN to another, etc.). GTP′ is used for transfer of charging data from GSNs to a charging function.

Referring to FIG. 2B, the GGSN 225B acts as an interface between a GPRS backbone network (not shown) and the Internet 175. The GGSN 225B extracts packet data with associated a packet data protocol (PDP) format (e.g., IP or PPP) from GPRS packets coming from the SGSN 220B, and sends the packets out on a corresponding packet data network. In the other direction, the incoming data packets are directed by the GGSN connected UE to the SGSN 220B which manages and controls the Radio Access Bearer (RAB) of a target UE served by the RAN 120. Thereby, the GGSN 225B stores the current SGSN address of the target UE and its associated profile in a location register (e.g., within a PDP context). The GGSN 225B is responsible for IP address assignment and is the default router for a connected UE. The GGSN 225B also performs authentication and charging functions.

The SGSN 220B is representative of one of many SGSNs within the core network 140, in an example. Each SGSN is responsible for the delivery of data packets from and to the UEs within an associated geographical service area. The tasks of the SGSN 220B includes packet routing and transfer, mobility management (e.g., attach/detach and location management), logical link management, and authentication and charging functions. The location register of the SGSN 220B stores location information (e.g., current cell, current VLR) and user profiles (e.g., IMSI, PDP address(es) used in the packet data network) of all GPRS users registered with the SGSN 220B, for example, within one or more PDP contexts for each user or UE. Thus, SGSNs 220B are responsible for (i) de-tunneling downlink GTP packets from the GGSN 225B, (ii) uplink tunnel IP packets toward the GGSN 225B, (iii) carrying out mobility management as UEs move between SGSN service areas and (iv) billing mobile subscribers. As will be appreciated by one of ordinary skill in the art, aside from (i)-(iv), SGSNs configured for GSM/EDGE networks have slightly different functionality as compared to SGSNs configured for W-CDMA networks.

The RAN 120 (e.g., or UTRAN, in UMTS system architecture) communicates with the SGSN 220B via a Radio Access Network Application Part (RANAP) protocol. RANAP operates over a Iu interface (Iu-ps), with a transmission protocol such as Frame Relay or IP. The SGSN 220B communicates with the GGSN 225B via a Gn interface, which is an IP-based interface between SGSN 220B and other SGSNs (not shown) and internal GGSNs (not shown), and uses the GTP protocol defined above (e.g., GTP-U, GTP-C, GTP′, etc.). In the embodiment of FIG. 2B, the Gn between the SGSN 220B and the GGSN 225B carries both the GTP-C and the GTP-U. While not shown in FIG. 2B, the Gn interface is also used by the Domain Name System (DNS). The GGSN 225B is connected to a Public Data Network (PDN) (not shown), and in turn to the Internet 175, via a Gi interface with IP protocols either directly or through a Wireless Application Protocol (WAP) gateway.

FIG. 2C illustrates another example configuration of the RAN 120 and a packet-switched portion of the core network 140 that is configured as a GPRS core network within a 3G UMTS W-CDMA system in accordance with an embodiment of the invention. Similar to FIG. 2B, the core network 140 includes the SGSN 220B and the GGSN 225B. However, in FIG. 2C, Direct Tunnel is an optional function in Iu mode that allows the SGSN 220B to establish a direct user plane tunnel, GTP-U, between the RAN 120 and the GGSN 225B within a PS domain. A Direct Tunnel capable SGSN, such as SGSN 220B in FIG. 2C, can be configured on a per GGSN and per RNC basis whether or not the SGSN 220B can use a direct user plane connection. The SGSN 220B in FIG. 2C handles the control plane signaling and makes the decision of when to establish Direct Tunnel. When the RAB assigned for a PDP context is released (i.e. the PDP context is preserved) the GTP-U tunnel is established between the GGSN 225B and SGSN 220B in order to be able to handle the downlink packets.

FIG. 2D illustrates an example configuration of the RAN 120 and a packet-switched portion of the core network 140 based on an Evolved Packet System (EPS) or LTE network, in accordance with an embodiment of the invention. Referring to FIG. 2D, unlike the RAN 120 shown in FIGS. 2B-2C, the RAN 120 in the EPS/LTE network is configured with a plurality of Evolved Node Bs (ENodeBs or eNBs) 200D, 205D and 210D, without the RNC 215B from FIGS. 2B-2C. This is because ENodeBs in EPS/LTE networks do not require a separate controller (i.e., the RNC 215B) within the RAN 120 to communicate with the core network 140. In other words, some of the functionality of the RNC 215B from FIGS. 2B-2C is built into each respective eNodeB of the RAN 120 in FIG. 2D.

In FIG. 2D, the core network 140 includes a plurality of Mobility Management Entities (MMES) 215D and 220D, a Home Subscriber Server (HSS) 225D, a Serving Gateway (S-GW) 230D, a Packet Data Network Gateway (P-GW) 235D and a Policy and Charging Rules Function (PCRF) 240D. Network interfaces between these components, the RAN 120 and the Internet 175 are illustrated in FIG. 2D and are defined in Table 1 (below) as follows:

TABLE 1
EPS/LTE Core Network Connection Definitions

| Network Interface | Description |
|---|---|
| S1-MME | Reference point for the control plane protocol between RAN 120 and |
| | MME 215D. |
| S1-U | Reference point between RAN 120 and S-GW 230D for the per |
| | bearer user plane tunneling and inter-eNodeB path switching during |
| | handover. |
| S5 | Provides user plane tunneling and tunnel management between S- |
| | GW 230D and P-GW 235D. It is used for S-GW relocation due to |
| | UE mobility and if the S-GW 230D needs to connect to a non- |
| | collocated P-GW for the required PDN connectivity. |
| S6a | Enables transfer of subscription and authentication data for |
| | authenticating/authorizing user access to the evolved system |
| | (Authentication, Authorization, and Accounting [AAA] interface) |
| | between MME 215D and HSS 225D. |
| Gx | Provides transfer of Quality of Service (QoS) policy and charging |
| | rules from PCRF 240D to Policy a Charging Enforcement Function |
| | (PCEF) component (not shown) in the P-GW 235D. |
| S8 | Inter-PLMN reference point providing user and control plane |
| | between the S-GW 230D in a Visited Public Land Mobile Network |
| | (VPLMN) and the P-GW 235D in a Home Public Land Mobile |
| | Network (HPLMN). S8 is the inter-PLMN variant of S5. |
| S10 | Reference point between MMEs 215D and 220D for MME |
| | relocation and MME to MME information transfer. |
| S11 | Reference point between MME 215D and S-GW 230D. |
| SGi | Reference point between the P-GW 235D and the packet data |
| | network, shown in FIG. 2D as the Internet 175. The Packet data |
| | network may be an operator external public or private packet data |
| | network or an intra-operator packet data network (e.g., for provision |
| | of IMS services). This reference point corresponds to Gi for 3GPP |
| | accesses. |
| X2 | Reference point between two different eNodeBs used for UE |
| | handoffs. |
| Rx | Reference point between the PCRF 240D and an application function |
| | (AF) that is used to exchanged application-level session information, |
| | where the AF is represented in FIG. 1 by the application server 170. |

A high-level description of the components shown in the RAN 120 and core network 140 of FIG. 2D will now be described. However, these components are each well-known in the art from various 3GPP TS standards, and the description contained herein is not intended to be an exhaustive description of all functionalities performed by these components.

Referring to FIG. 2D, the MMEs 215D and 220D are configured to manage the control plane signaling for the EPS bearers. MME functions include: Non-Access Stratum (NAS) signaling, NAS signaling security, Mobility management for inter- and intra-technology handovers, P-GW and S-GW selection, and MME selection for handovers with MME change.

Referring to FIG. 2D, the S-GW 230D is the gateway that terminates the interface toward the RAN 120. For each UE associated with the core network 140 for an EPS-based system, at a given point of time, there is a single S-GW. The functions of the S-GW 230D, for both the GTP-based and the Proxy Mobile IPv6 (PMIP)-based S5/S8, include: Mobility anchor point, Packet routing and forwarding, and setting the DiffSery Code Point (DSCP) based on a QoS Class Identifier (QCI) of the associated EPS bearer.

Referring to FIG. 2D, the P-GW 235D is the gateway that terminates the SGi interface toward the Packet Data Network (PDN), e.g., the Internet 175. If a UE is accessing multiple PDNs, there may be more than one P-GW for that UE; however, a mix of S5/S8 connectivity and Gn/Gp connectivity is not typically supported for that UE simultaneously. P-GW functions include for both the GTP-based S5/S8: Packet filtering (by deep packet inspection), UE IP address allocation, setting the DSCP based on the QCI of the associated EPS bearer, accounting for inter operator charging, uplink (UL) and downlink (DL) bearer binding as defined in 3GPP TS 23.203, UL bearer binding verification as defined in 3GPP TS 23.203. The P-GW 235D provides PDN connectivity to both GSM/EDGE Radio Access Network (GERAN)/UTRAN only UEs and E-UTRAN-capable UEs using any of E-UTRAN, GERAN, or UTRAN. The P-GW 235D provides PDN connectivity to E-UTRAN capable UEs using E-UTRAN only over the S5/S8 interface.

Referring to FIG. 2D, the PCRF 240D is the policy and charging control element of the EPS-based core network 140. In a non-roaming scenario, there is a single PCRF in the HPLMN associated with a UE's Internet Protocol Connectivity Access Network (IP-CAN) session. The PCRF terminates the Rx interface and the Gx interface. In a roaming scenario with local breakout of traffic, there may be two PCRFs associated with a UE's IP-CAN session: A Home PCRF (H-PCRF) is a PCRF that resides within a HPLMN, and a Visited PCRF (V-PCRF) is a PCRF that resides within a visited VPLMN. PCRF is described in more detail in 3GPP TS 23.203, and as such will not be described further for the sake of brevity. In FIG. 2D, the application server 170 (e.g., which can be referred to as the AF in 3GPP terminology) is shown as connected to the core network 140 via the Internet 175, or alternatively to the PCRF 240D directly via an Rx interface. Generally, the application server 170 (or AF) is an element offering applications that use IP bearer resources with the core network (e.g. UMTS PS domain/GPRS domain resources/LTE PS data services). One example of an application function is the Proxy-Call Session Control Function (P-CSCF) of the IP Multimedia Subsystem (IMS) Core Network sub system. The AF uses the Rx reference point to provide session information to the PCRF 240D. Any other application server offering IP data services over cellular network can also be connected to the PCRF 240D via the Rx reference point.

FIG. 2E illustrates an example of the RAN 120 configured as an enhanced High Rate Packet Data (HRPD) RAN connected to an EPS or LTE network 140A and also a packet-switched portion of an HRPD core network 140B in accordance with an embodiment of the invention. The core network 140A is an EPS or LTE core network, similar to the core network described above with respect to FIG. 2D.

In FIG. 2E, the eHRPD RAN includes a plurality of base transceiver stations (BTSs) 200E, 205E and 210E, which are connected to an enhanced BSC (eBSC) and enhanced PCF (ePCF) 215E. The eBSC/ePCF 215E can connect to one of the MMEs 215D or 220D within the EPS core network 140A over an S101 interface, and to an HRPD serving gateway (HSGW) 220E over A10 and/or A11 interfaces for interfacing with other entities in the EPS core network 140A (e.g., the S-GW 220D over an S103 interface, the P-GW 235D over an S2a interface, the PCRF 240D over a Gxa interface, a 3GPP AAA server (not shown explicitly in FIG. 2D) over an STa interface, etc.). The HSGW 220E is defined in 3GPP2 to provide the interworking between HRPD networks and EPS/LTE networks. As will be appreciated, the eHRPD RAN and the HSGW 220E are configured with interface functionality to EPC/LTE networks that is not available in legacy HRPD networks.

Turning back to the eHRPD RAN, in addition to interfacing with the EPS/LTE network 140A, the eHRPD RAN can also interface with legacy HRPD networks such as HRPD network 140B. As will be appreciated the HRPD network 140B is an example implementation of a legacy HRPD network, such as the EV-DO network from FIG. 2A. For example, the eBSC/ePCF 215E can interface with an authentication, authorization and accounting (AAA) server 225E via an A12 interface, or to a PDSN/FA 230E via an A10 or A11 interface. The PDSN/FA 230E in turn connects to HA 235A, through which the Internet 175 can be accessed. In FIG. 2E, certain interfaces (e.g., A13, A16, H1, H2, etc.) are not described explicitly but are shown for completeness and would be understood by one of ordinary skill in the art familiar with HRPD or eHRPD.

Referring to FIGS. 2B-2E, it will be appreciated that LTE core networks (e.g., FIG. 2D) and HRPD core networks that interface with eHRPD RANs and HSGWs (e.g., FIG. 2E) can support network-initiated Quality of Service (QoS) (e.g., by the P-GW, GGSN, SGSN, etc.) in certain cases.

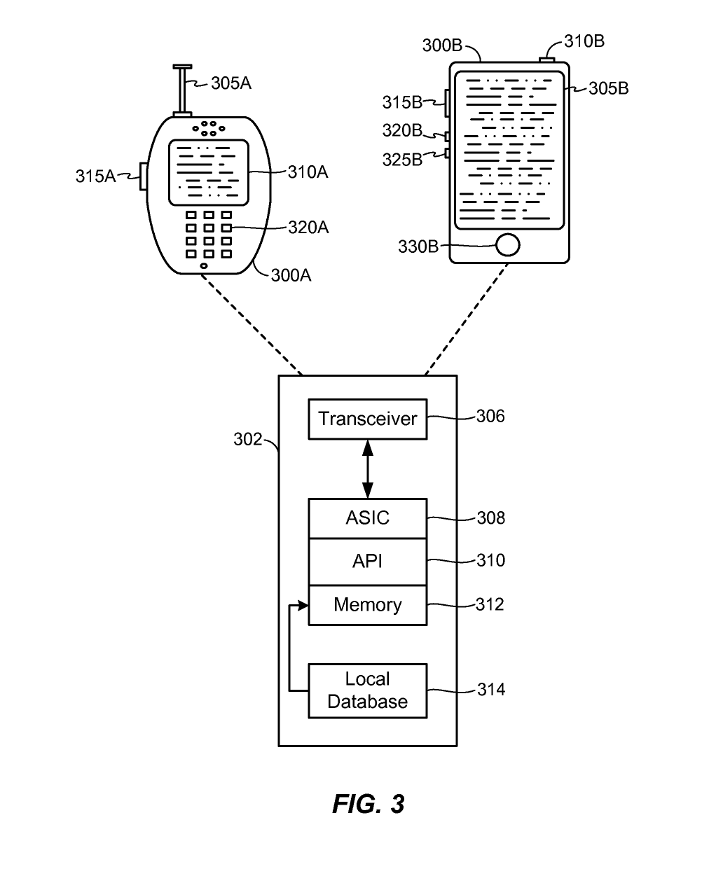

FIG. 3 illustrates examples of UEs in accordance with embodiments of the invention. Referring to FIG. 3, UE 300A is illustrated as a calling telephone and UE 300B is illustrated as a touchscreen device (e.g., a smart phone, a tablet computer, etc.). As shown in FIG. 3, an external casing of UE 300A is configured with an antenna 305A, display 310A, at least one button 315A (e.g., a PTT button, a power button, a volume control button, etc.) and a keypad 320A among other components, as is known in the art. Also, an external casing of UE 300B is configured with a touchscreen display 305B, peripheral buttons 310B, 315B, 320B and 325B (e.g., a power control button, a volume or vibrate control button, an airplane mode toggle button, etc.), at least one front-panel button 330B (e.g., a Home button, etc.), among other components, as is known in the art. While not shown explicitly as part of UE 300B, the UE 300B can include one or more external antennas and/or one or more integrated antennas that are built into the external casing of UE 300B, including but not limited to WiFi antennas, cellular antennas, satellite position system (SPS) antennas (e.g., global positioning system (GPS) antennas), and so on.

While internal components of UEs such as the UEs 300A and 300B can be embodied with different hardware configurations, a basic high-level UE configuration for internal hardware components is shown as platform 302 in FIG. 3. The platform 302 can receive and execute software applications, data and/or commands transmitted from the RAN 120 that may ultimately come from the core network 140, the Internet 175 and/or other remote servers and networks (e.g., application server 170, web URLs, etc.). The platform 302 can also independently execute locally stored applications without RAN interaction. The platform 302 can include a transceiver 306 operably coupled to an application specific integrated circuit (ASIC) 308, or other processor, microprocessor, logic circuit, or other data processing device. The ASIC 308 or other processor executes the application programming interface (API) 310 layer that interfaces with any resident programs in the memory 312 of the wireless device. The memory 312 can be comprised of read-only or random-access memory (RAM and ROM), EEPROM, flash cards, or any memory common to computer platforms. The platform 302 also can include a local database 314 that can store applications not actively used in memory 312, as well as other data. The local database 314 is typically a flash memory cell, but can be any secondary storage device as known in the art, such as magnetic media, EEPROM, optical media, tape, soft or hard disk, or the like.

Accordingly, an embodiment of the invention can include a UE (e.g., UE 300A, 300B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 308, memory 312, API 310 and local database 314 may all be used cooperatively to load, store and execute the various functions disclosed herein and thus the logic to perform these functions may be distributed over various elements. Alternatively, the functionality could be incorporated into one discrete component. Therefore, the features of the UEs 300A and 300B in FIG. 3 are to be considered merely illustrative and the invention is not limited to the illustrated features or arrangement.

The wireless communication between the UEs 300A and/or 300B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

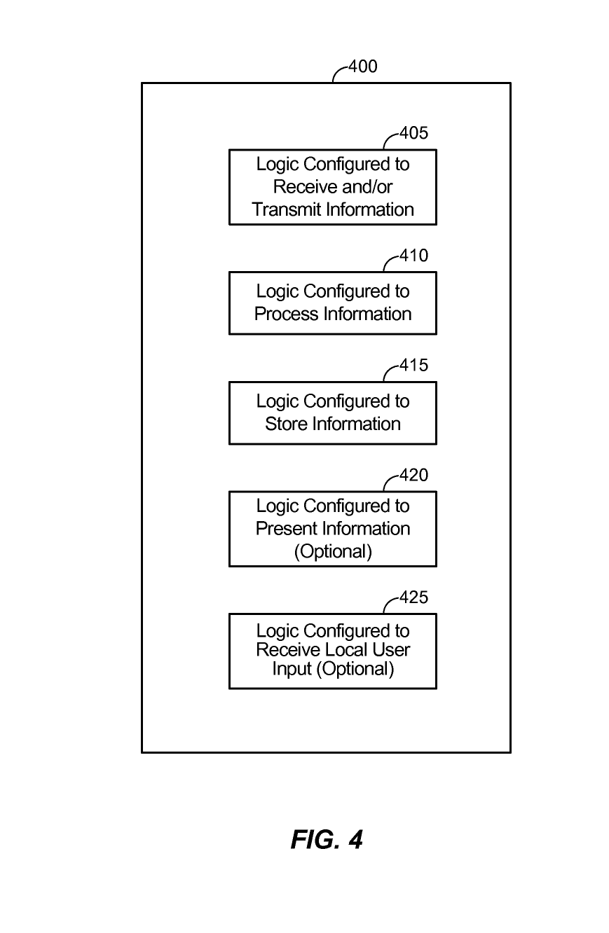

FIG. 4 illustrates a communication device 400 that includes logic configured to perform functionality. The communication device 400 can correspond to any of the above-noted communication devices, including but not limited to UEs 300A or 300B, any component of the RAN 120 (e.g., BSs 200A through 210A, BSC 215A, Node Bs 200B through 210B, RNC 215B, eNodeBs 200D through 210D, etc.), any component of the core network 140 (e.g., PCF 220A, PDSN 225A, SGSN 220B, GGSN 225B, MME 215D or 220D, HSS 225D, S-GW 230D, P-GW 235D, PCRF 240D), any components coupled with the core network 140 and/or the Internet 175 (e.g., the application server 170), and so on. Thus, communication device 400 can correspond to any electronic device that is configured to communicate with (or facilitate communication with) one or more other entities over the wireless communications system 100 of FIG. 1.

Referring to FIG. 4, the communication device 400 includes logic configured to receive and/or transmit information 405. In an example, if the communication device 400 corresponds to a wireless communications device (e.g., UE 300A or 300B, one of BSs 200A through 210A, one of Node Bs 200B through 210B, one of eNodeBs 200D through 210D, etc.), the logic configured to receive and/or transmit information 405 can include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 405 can correspond to a wired communications interface (e.g., a serial connection, a USB or Firewire connection, an Ethernet connection through which the Internet 175 can be accessed, etc.). Thus, if the communication device 400 corresponds to some type of network-based server (e.g., PDSN, SGSN, GGSN, S-GW, P-GW, MME, HSS, PCRF, the application 170, etc.), the logic configured to receive and/or transmit information 405 can correspond to an Ethernet card, in an example, that connects the network-based server to other communication entities via an Ethernet protocol. In a further example, the logic configured to receive and/or transmit information 405 can include sensory or measurement hardware by which the communication device 400 can monitor its local environment (e.g., an accelerometer, a temperature sensor, a light sensor, an antenna for monitoring local RF signals, etc.). The logic configured to receive and/or transmit information 405 can also include software that, when executed, permits the associated hardware of the logic configured to receive and/or transmit information 405 to perform its reception and/or transmission function(s). However, the logic configured to receive and/or transmit information 405 does not correspond to software alone, and the logic configured to receive and/or transmit information 405 relies at least in part upon hardware to achieve its functionality.

Referring to FIG. 4, the communication device 400 further includes logic configured to process information 410. In an example, the logic configured to process information 410 can include at least a processor. Example implementations of the type of processing that can be performed by the logic configured to process information 410 includes but is not limited to performing determinations, establishing connections, making selections between different information options, performing evaluations related to data, interacting with sensors coupled to the communication device 400 to perform measurement operations, converting information from one format to another (e.g., between different protocols such as .wmv to .avi, etc.), and so on. For example, the processor included in the logic configured to process information 410 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 410 can also include software that, when executed, permits the associated hardware of the logic configured to process information 410 to perform its processing function(s). However, the logic configured to process information 410 does not correspond to software alone, and the logic configured to process information 410 relies at least in part upon hardware to achieve its functionality.

Referring to FIG. 4, the communication device 400 further includes logic configured to store information 415. In an example, the logic configured to store information 415 can include at least a non-transitory memory and associated hardware (e.g., a memory controller, etc.). For example, the non-transitory memory included in the logic configured to store information 415 can correspond to RAM memory, flash memory, ROM memory, EPROM memory, EEPROM memory, registers, hard disk, a removable disk, a CD-ROM, or any other form of storage medium known in the art. The logic configured to store information 415 can also include software that, when executed, permits the associated hardware of the logic configured to store information 415 to perform its storage function(s). However, the logic configured to store information 415 does not correspond to software alone, and the logic configured to store information 415 relies at least in part upon hardware to achieve its functionality.

Referring to FIG. 4, the communication device 400 further optionally includes logic configured to present information 420. In an example, the logic configured to present information 420 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 400. For example, if the communication device 400 corresponds to UE 300A or UE 300B as shown in FIG. 3, the logic configured to present information 420 can include the display 310A of UE 300A or the touchscreen display 305B of UE 300B. In a further example, the logic configured to present information 420 can be omitted for certain communication devices, such as network communication devices that do not have a local user (e.g., network switches or routers, remote servers, etc.). The logic configured to present information 420 can also include software that, when executed, permits the associated hardware of the logic configured to present information 420 to perform its presentation function(s). However, the logic configured to present information 420 does not correspond to software alone, and the logic configured to present information 420 relies at least in part upon hardware to achieve its functionality.

Referring to FIG. 4, the communication device 400 further optionally includes logic configured to receive local user input 425. In an example, the logic configured to receive local user input 425 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 400. For example, if the communication device 400 corresponds to UE 300A or UE 300B as shown in FIG. 3, the logic configured to receive local user input 425 can include the keypad 320A, any of the buttons 315A or 310B through 325B, the touchscreen display 305B, etc. In a further example, the logic configured to receive local user input 425 can be omitted for certain communication devices, such as network communication devices that do not have a local user (e.g., network switches or routers, remote servers, etc.). The logic configured to receive local user input 425 can also include software that, when executed, permits the associated hardware of the logic configured to receive local user input 425 to perform its input reception function(s). However, the logic configured to receive local user input 425 does not correspond to software alone, and the logic configured to receive local user input 425 relies at least in part upon hardware to achieve its functionality.

Referring to FIG. 4, while the configured logics of 405 through 425 are shown as separate or distinct blocks in FIG. 4, it will be appreciated that the hardware and/or software by which the respective configured logic performs its functionality can overlap in part. For example, any software used to facilitate the functionality of the configured logics of 405 through 425 can be stored in the non-transitory memory associated with the logic configured to store information 415, such that the configured logics of 405 through 425 each performs their functionality (i.e., in this case, software execution) based in part upon the operation of software stored by the logic configured to store information 415. Likewise, hardware that is directly associated with one of the configured logics can be borrowed or used by other configured logics from time to time. For example, the processor of the logic configured to process information 410 can format data into an appropriate format before being transmitted by the logic configured to receive and/or transmit information 405, such that the logic configured to receive and/or transmit information 405 performs its functionality (i.e., in this case, transmission of data) based in part upon the operation of hardware (i.e., the processor) associated with the logic configured to process information 410.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

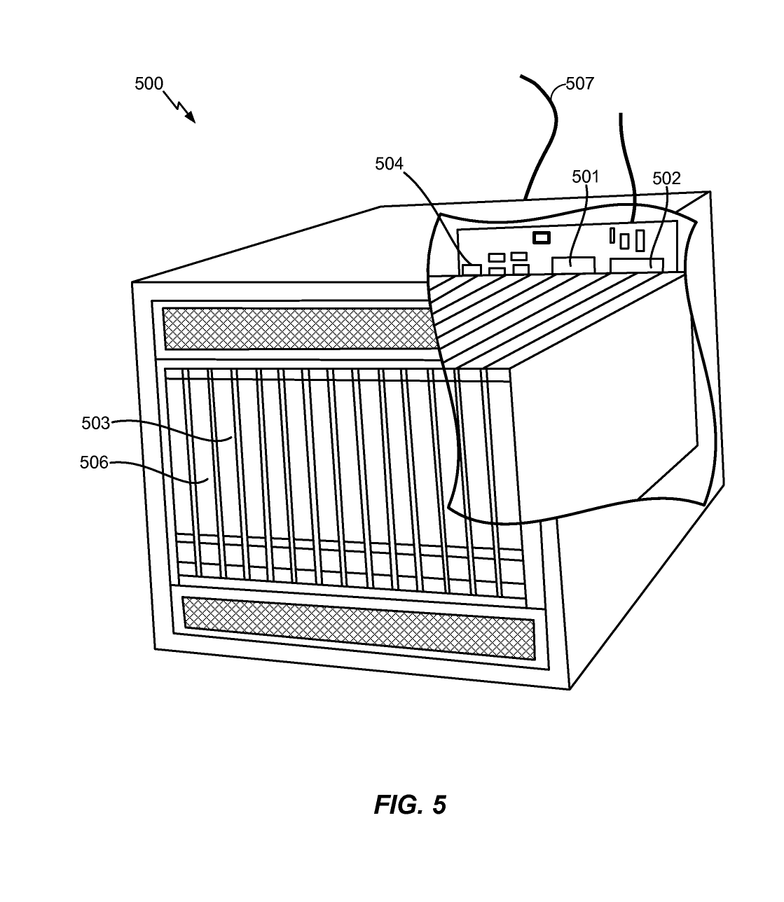

The various embodiments may be implemented on any of a variety of commercially available server devices, such as server 500 illustrated in FIG. 5. In an example, the server 500 may correspond to one example configuration of the application server 170 described above. In FIG. 5, the server 500 includes a processor 500 coupled to volatile memory 502 and a large capacity nonvolatile memory, such as a disk drive 503. The server 500 may also include a floppy disc drive, compact disc (CD) or DVD disc drive 506 coupled to the processor 501. The server 500 may also include network access ports 504 coupled to the processor 501 for establishing data connections with a network 507, such as a local area network coupled to other broadcast system computers and servers or to the Internet. In context with FIG. 4, it will be appreciated that the server 500 of FIG. 5 illustrates one example implementation of the communication device 400, whereby the logic configured to transmit and/or receive information 405 corresponds to the network access ports 504 used by the server 500 to communicate with the network 507, the logic configured to process information 410 corresponds to the processor 501, and the logic configuration to store information 415 corresponds to any combination of the volatile memory 502, the disk drive 503 and/or the disc drive 506. The optional logic configured to present information 420 and the optional logic configured to receive local user input 425 are not shown explicitly in FIG. 5 and may or may not be included therein. Thus, FIG. 5 helps to demonstrate that the communication device 400 may be implemented as a server, in addition to a UE implementation as in 305A or 305B as in FIG. 3.

Certain client applications that execute on UEs require that their respective UEs, when idle, use a short paging cycle interval (referred to hereinafter as “paging cycle” or DRX cycle, e.g., 0.5 seconds, 1.5 seconds, etc.) in order to provide quick call setup times. Examples of such client applications include client applications that are expected to engage in delay-sensitive communication sessions that are arbitrated by the application server 170 and require shorter call set-up times (e.g., PTT sessions, emergency dispatch services, etc.). When using a shorter paging cycle, the UE will wake up more often to determine if it is being paged. If the UE determines that it is not being paged, the UE will turn off its modem hardware and go back to sleep until the next paging cycle. On the other hand, if the UE determines that it is being paged, the UE will transition into an active channel state in order to respond to the page. While shorter paging cycles decrease call set-up times, shorter paging cycles also decrease mobile battery life due to the modem hardware on the UE being powered on more often. For this reason, it is common for operators to prefer a medium to longer paging cycle (e.g., 5 seconds, 8 seconds, etc.).

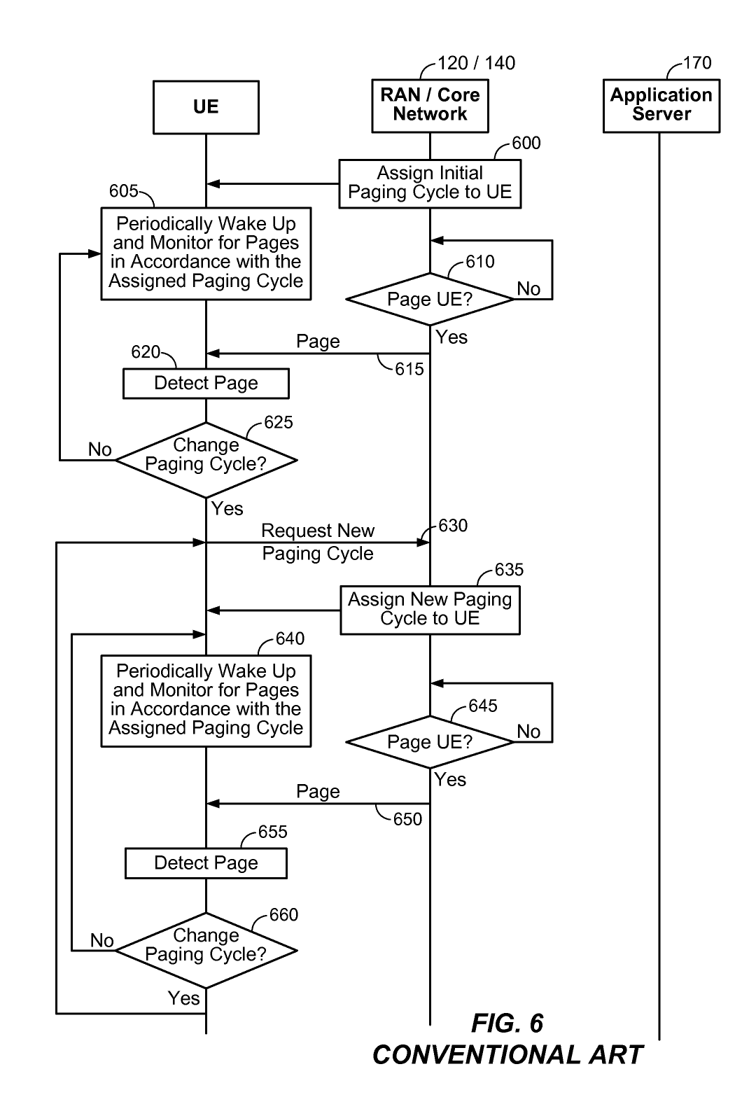

For a given client application expected to engage in delay-sensitive communication sessions that are arbitrated by the application server 170 and require shorter call set-up times, the given client application can attempt to request its desired, shorter paging cycle during operation. FIG. 6 illustrates a conventional UE-initiated paging cycle adjustment procedure. With reference to the FIG. 6 as well as the other FIGS described below, paging cycle adjustments are disclosed as being implemented by a “RAN-core network”, denoted in the respect FIGS as RAN/Core Network 120/140. As will be appreciated, in certain network configurations (e.g., EV-DO as in FIG. 2A, UMTS/W-CDMA as in FIGS. 2B-2C, etc.), the RAN 120 is responsible for assigning the DRX or paging cycles used by UEs, and in other network configurations (e.g., LTE as in FIG. 2D, etc.), the core network 140 is responsible for assigning the DRX or paging cycles used by UEs. Accordingly, reference to the RAN-core network invokes whichever network component is responsible for assigning paging cycles to UEs in that network, such that the FIGS are generic in terms of network configuration.

Referring to FIG. 6, the RAN-core network assigns an initial paging cycle to a given UE, 600, and the given UE periodically wakes up and monitors a downlink paging channel for pages from the RAN-core network in accordance with its assigned paging cycle, 605. The RAN-core network periodically determines whether to page the given UE, 610. For example, the RAN-core network can determine to page the given UE if the given UE is operating in an idle or dormant mode (e.g., CELL_PCH or URA_PCH state, etc.) when data (e.g., a call announcement message, an alert message, a text message, etc.) arrives at the RAN-core network for transmission to the given UE. If the RAN-core network determines not to page the given UE at 610, no page is transmitted. Otherwise, if the RAN-core network determines to page the given UE at 610, the RAN-core network waits for the next time at which at which the given UE is expected to monitor for pages based on its assigned paging cycle, and then transmits a page to the given UE on the downlink paging channel, 615. Because the given UE is periodically waking up to check for pages on the downlink paging channel in accordance its assigned paging cycle at 605, the given UE detects the page on the downlink paging channel, 620.

During operation, the given UE determines whether to request that the RAN-core network change its paging cycle, 625. If the given UE determines not to request that the RAN-core network change its paging cycle at 625, the given UE continues to wake up and monitor for pages on the downlink paging channel in accordance with its assigned paging cycle. Otherwise, if the given UE determines to request that the RAN-core network change its paging cycle at 625 (e.g., in response to a request from the given client application to facilitate quicker call set-up times for delay-sensitive communication sessions), the given UE transmits a request for the RAN-core network to change its paging cycle, 630.

In FIG. 6, assume that the RAN-core network grants the given UE's page cycle adjustment request from 630. Accordingly, the RAN-core network assigns a new paging cycle to the given UE, 635, after which the given UE periodically wakes up and monitors the downlink paging channel for pages from the RAN-core network in accordance with the new paging cycle, 640.

The RAN-core network periodically determines whether to page the given UE, 645 (similar to 610). If the RAN-core network determines not to page the given UE at 645, no page is transmitted. Otherwise, if the RAN-core network determines to page the given UE at 645, the RAN-core network waits for the next time at which at which the given UE is expected to monitor for pages based on the new paging cycle, and then transmits a page to the given UE on the downlink paging channel, 650. Because the given UE is periodically waking up to check for pages on the downlink paging channel in accordance the new paging cycle at 640, the given UE detects the page on the downlink paging channel, 655.

During operation, the given UE continues to determine whether to request that the RAN-core network change its paging cycle, 660 (similar to 625). If the given UE determines not to request that the RAN-core network change its paging cycle at 660, the given UE continues to wake up and monitor for pages on the downlink paging channel in accordance with its currently assigned paging cycle. Otherwise, if the given UE determines to request that the RAN-core network change its paging cycle at 660, the given UE transmits another request for the RAN-core network to change its paging cycle, 630, and so on.

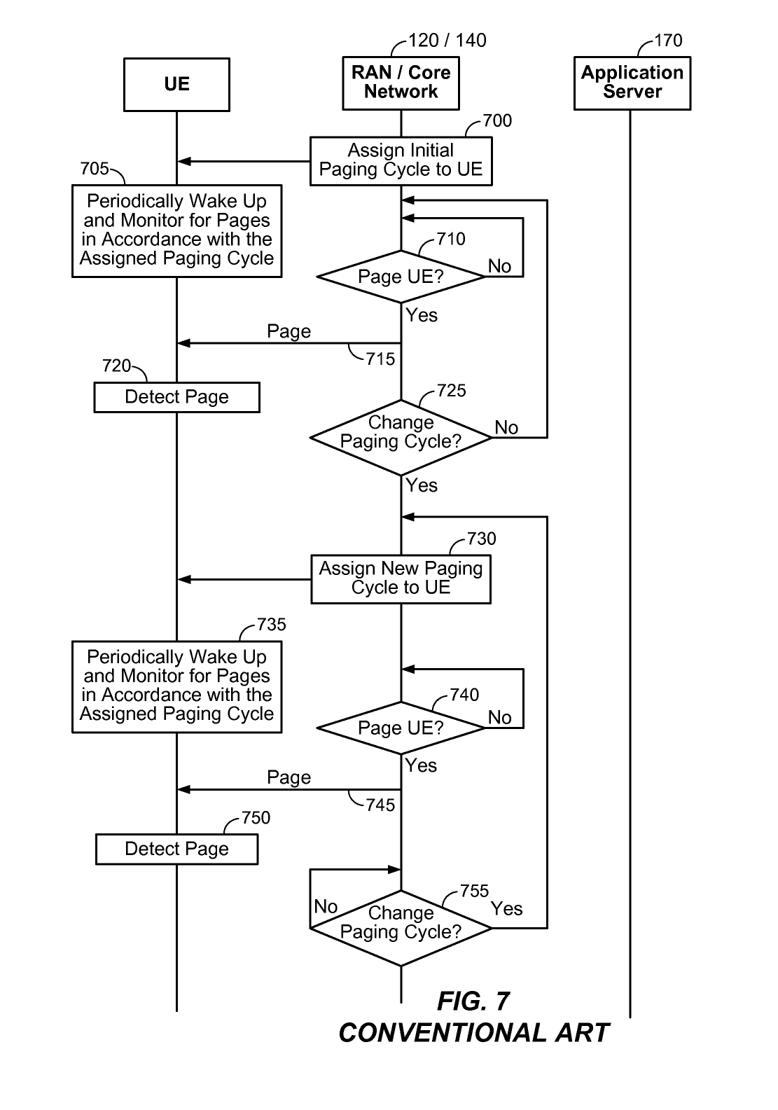

While FIG. 6 illustrates a UE-initiated paging cycle adjustment procedure, it is also possible that the RAN-core network itself may update the paging cycle used by one or more of its UEs on its own initiative, as shown in FIG. 7. Referring to FIG. 7, 700 through 720 correspond to 600 through 620 of FIG. 6, and will not be described further for the sake of brevity. At 725, the RAN-core network (instead of the given UE) determines whether to change the given UE's paging cycle, 725. If the RAN-core network determines not to change the given UE's paging cycle at 725, the given UE's paging cycle remains unchanged. Otherwise, if the RAN-core network determines to change the given UE's paging cycle at 725, the RAN-core network assigns a new paging cycle to the given UE, 730, after which the given UE periodically wakes up and monitors the downlink paging channel for pages from the RAN-core network in accordance with the new paging cycle, 735.

Referring to FIG. 7, 740 through 750 correspond to 645 through 655 of FIG. 6, and will not be described further for the sake of brevity. At 755, the RAN-core network again determines whether to change the given UE's paging cycle. If the RAN-core network determines not to change the given UE's paging cycle at 755, the given UE's paging cycle remains unchanged. Otherwise, if the RAN-core network determines to change the given UE's paging cycle again at 755, the process returns to 730 whereby the RAN-core network assigns another paging cycle to the given UE, 730, after which the given UE periodically wakes up and monitors the downlink paging channel for pages from the RAN-core network in accordance with the new paging cycle, 735, and so on.

As shown in FIGS. 6-7, it is sometimes possible for either the given UE itself or the RAN-core network to adapt the paging cycle assigned to the given UE. However, the RAN-core network is not necessarily aware of the particular paging cycle requirements of individual client applications executing on the given UE, such that the RAN-core network-initiated approach of FIG. 7 does not necessarily satisfy these paging cycle requirements, if present. Also, the given client application cannot always initiate a paging cycle request on its respective UE. For example, some UEs do not support a mechanism that permits downloaded client applications to adjust the paging cycles used by those UEs. In fact, some operating systems (OSs) that are installed on certain UEs hide the paging cycle used by the UEs from higher-level client applications executing thereon, so the given client application may have no way of ascertaining the paging cycle being used on its respective UE in order to request a paging cycle adjustment. Embodiments of the invention are thereby directed to initiating paging cycle adjustments for paging cycles assigned to UEs executing a particular client application at the application server 170, instead of the UEs themselves (as in FIG. 6) or the RAN-core network (as in FIG. 7).

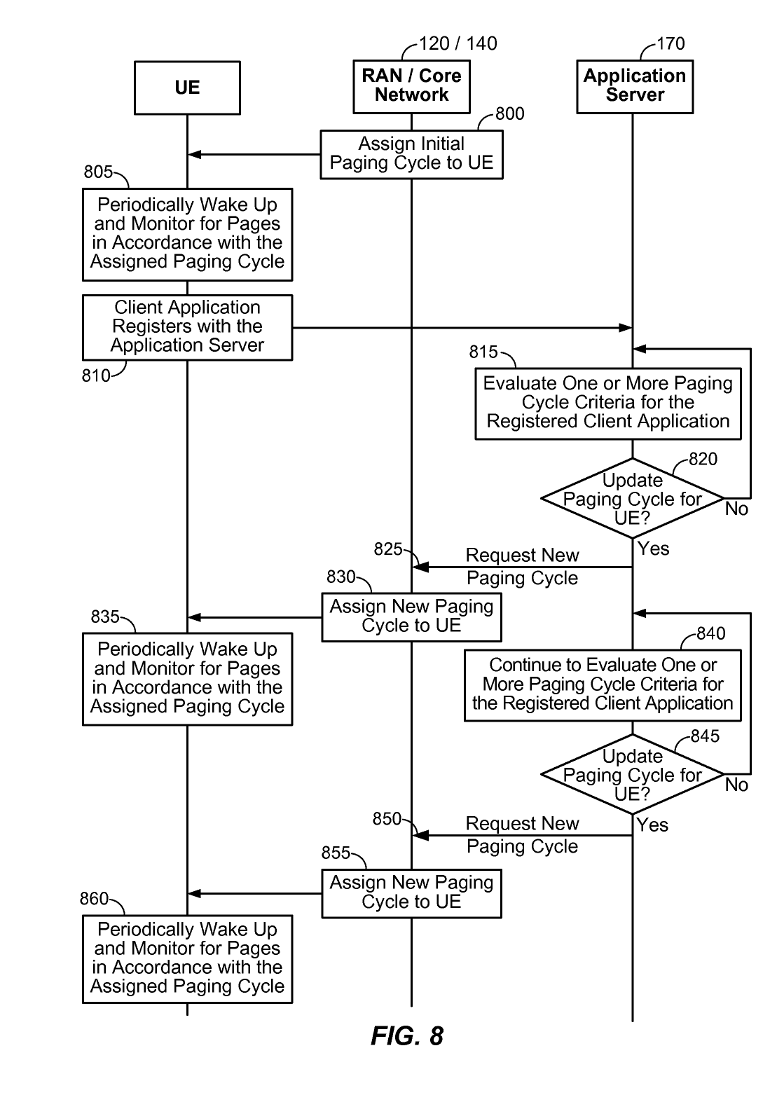

FIG. 8 illustrates a server-initiated paging cycle adjustment procedure in accordance with an embodiment of the invention. Referring to FIG. 8, the RAN-core network assigns an initial paging cycle to a given UE, 800, and the given UE periodically wakes up and monitors a downlink paging channel for pages from the RAN-core network in accordance with its assigned paging cycle, 805. While not actually shown in FIG. 8, it will be appreciated that the RAN-core network may send pages to the given UE based on the initial paging cycle at any point after 805, and the given UE may detect and respond to these pages.

Referring to FIG. 8, at some point after the initial paging cycle is assigned at 800, a given client application on the given UE registers with the application server 170, 810. In an example, the given client application is associated with communication sessions that are at least sometimes delay-sensitive in terms of their call set-up times, including but not limited to push-to-talk (PTT) sessions, group sessions for emergency dispatch services where every second of call set-up delay can be critical, and so on. The application server 170 registers the given client application and, at some point in conjunction with or after the registration of the given client application, the application server 170 evaluates one or more paging cycle criteria for the registered client application, 815. Based on the evaluation of 815, the application server 170 determines whether to update the paging cycle used by the given UE at 820. The one or more paging cycle criteria can include any criterion that can potentially be relevant to the server-initiated decision pertaining to whether or not to modify the paging cycle used by the given UE at 820.

Referring to FIG. 8, as an example, the one or more paging cycle criteria can include (i) a device type of the given UE, (ii) a battery level of the given UE, (iii) a priority of a user of the given UE, (iv) a group to which the user of the given UE is a member, (v) system load, (vi) whether an emergency is occurring if the given UE is associated with an emergency dispatch service, (vii) whether a call history associated with either the user or the given UE indicates a lower or higher likelihood of delay-sensitive communication sessions targeted to the given UE, (viii) whether the given client application is associated with one-to-one or group communication sessions, (ix) whether the user the given UE is expected to receive a call based on a known calendar entry or schedule of the user or another user, (x) whether the given client application completes its registration with the application server 170, or (xi) any combination thereof. As will be appreciated, the list provided above is not provided for example purposes only, and the one or more paging cycle criteria can include other paging criteria as well.

With reference to the examples of paging cycle criteria provided in the preceding paragraphs, it will be appreciated that the paging cycle criteria can factor into the application server's 170 at 820 in a number of different ways. For example, in case of (i), certain device types may be known by the application server 170 to have a particularly strong battery, which can prompt the application server 170 to determine to update the given UE with a shorter or more aggressive paging cycle at 820 (or vice versa). In another example, in case of (ii), the battery level of the given UE may be reported as being low in conjunction with the registration of 810 (or a supplemental battery power update message), which can prompt the application server 170 to determine to update the given UE with a longer or less aggressive paging cycle at 820 (or vice versa). Table 2 (below) represents an example of paging cycle criteria and associated paging cycle configurations that can be decided by the application server 170 at 820:

TABLE 2
Example Decision Logic for 820 of FIG. 8

| | Paging Cycle Configuration |
|---|---|
| Relevant Paging Cycle Criteria | Decision |
| Device Type = Weak Battery | Longer Paging Cycle |
| Current Battery Level = High | Shorter Paging Cycle |
| User Priority = Low, and | Longer Paging Cycle |
| System Load = High | |
| Call History indicates UE unlikely to receive | Intermediate Paging Cycle |
| calls; and Current Battery | |
| Level = Intermediate | |
| UE is operated by an emergency responder; | Longer Paging Cycle |
| and No emergencies are active | |
| UE is scheduled to be called by another UE | Shorter Paging Cycle |
| based on a calendar entry for the user | |
| Client application completes registration | Shorter Paging Cycle |
| with the application server 170 | |
| UE belongs to a communication group that | Shorter Paging Cycle |
| engages in frequent sessions and/or | |
| high-priority sessions | |
| UE Presence = Do Not Disturb (ON) | Longer Paging Cycle |
| UE Presence = Do Not Disturb (OFF) | Shorter Paging Cycle |
| Radio Access Technology (RAT) of a | UMTS = Longer Paging |
| serving RAN/core network = LTE or UMTS | Cycle |
| or WiFi | LTE = Intermediate Paging |
| | Cycle |
| | WiFi = Shorter Paging |
| | Cycle |

Accordingly, Table 2 (above) illustrates one set of examples for the types of paging cycles that may be established for different paging cycle criteria conditions. Further, it will be appreciated that the converses of the examples in Table 2 can also be extrapolated. For example, if the Device Type is not associated with “Weak Battery”, than the longer paging cycle is not used, and if the Device Type is actually associated with “Strong Battery” than a shorter paging cycle could be used (at least, no shorter than a current paging cycle expectation). While not shown in Table 2, it is also possible that the application server 170 may simply determine not to change the current paging cycle used by the given UE. The application server 170 does not need to shorten or extend the paging cycle at each execution of 820 of FIG. 8, in other words. Further, it will be appreciated that the description of a paging cycle as being “longer” or “shorter” is relative. In certain contexts, the “shorter” paging cycle could be a default (or intermediate) paging cycle (e.g., a paging cycle allocated to the UE without interference from the application server 170) with the “longer” paging cycle being any paging cycle that is longer than the default or intermediate paging cycle. Likewise, in other contexts, the “longer” paging cycle could be the default or intermediate paging cycle with the “shorter” paging cycle being any paging cycle that is shorter than the default or intermediate paging cycle. In yet other contexts, the “shorter” paging cycle can be shorter than the default or intermediate paging cycle and the “longer” paging cycle can be longer than the default or intermediate paging cycle. In yet other contexts, the “shorter” and “longer” paging cycles can both be longer or shorter than the default or intermediate paging cycle. In other words, the various examples shown in Table 2 (above) can each be context-specific. For example, the “shorter” paging cycle for the scenario where UE presence is associated with a Do Not Disturb feature being turned ON is shorter than the “longer” paging cycle for the scenario where the UE presence is associated with the Do Not Disturb feature being turned OFF because the context (e.g., Do Not Disturb feature status) is the same. However, the “shorter” paging cycle in the Do Not Disturb context could be longer than the “longer” paging cycle in some other context, such as an emergency context characterized by emergency responder UEs during a non-emergency. Thus, a given context (e.g., emergency context, Do Not Disturb context, battery level context) can be associated with relative “longer” or “shorter” paging cycles based on a context-specific status without the relative paging cycles necessarily being the same from context to context.

Further, while not shown in FIG. 8 explicitly, in an embodiment, the application server 170 may be notified of the current paging cycle used by the given UE either by the given UE or the RAN-core network. If the given UE is responsible for keeping the application server 170 up-to-date with respect to its current paging cycle (e.g., assuming that the given client application is actually permitted access to the given UE's paging cycle, which is not always the case for all OSs), the given UE may notify the application server 170 of its paging cycle in conjunction with the registration at 810, and thereafter the given UE may provide supplemental paging cycle updates to the application server 170 whenever the RAN-core network changes its paging cycle so long as the given client application remains registered with the application server 170. Alternatively, if the RAN-core network is responsible for keeping the application server 170 up-to-date with respect to its current paging cycle, the RAN-core network may notify the application server 170 of the given UE's paging cycle may provide paging cycle updates to the application server 170 whenever the RAN-core network changes the given UE's paging cycle. Alternatively, the given UE or the RAN-core network may provide the given UE's assigned paging cycle in response to one or more paging cycle queries issued by the application server 170 to the given UE or the RAN-core network. In yet another example, the application server 170 may not attempt to track the current paging cycle of the given UE at all during the evaluation and decision of 815-820. Instead, the application server 170 may simply calculate a desired paging cycle for the given UE and ‘blindly’ request that the RAN-core network set the given UE's paging cycle to the calculated level.

Turning back to 820 of FIG. 8, if the application server 170 determines not to update the paging cycle for the given UE at 820 (e.g., the current paging cycle is deemed appropriate, etc.), then no paging cycle adjustment is initiated by the application server 170. Otherwise, if the application server 170 determines to update the paging cycle for the given UE at 820, the application server 170 transmits a request to the RAN-core network for the given UE's paging cycle to be transitioned to the new paging cycle, 825. In an example, the request of 825 can either be sent on a proprietary interface that is not explicitly defined by the relevant standard for the respective network configuration of the RAN-core network, or alternatively can leverage one or more existing communication interfaces of the relevant standard for the respective network configuration of the RAN-core network. Generally, the relevant standards of the respective network configurations of the RAN-core network do not define a mechanism by which external servers, such as the application server 170, can issue paging cycle modification requests to the RAN-core network.

Referring to FIG. 8, the RAN-core network receives the paging cycle request of 825 and the RAN-core network assigns the requested new paging cycle to the given UE, 830, after which the given UE periodically wakes up and monitors the downlink paging channel for pages from the RAN-core network in accordance with the new paging cycle, 835. During operation, the application server 170 continues to evaluate the one or more paging cycle criteria, 840 (similar to 815), and the application server 170 determines whether to make any additional adjustments to the given UE's paging cycle based on the evaluation, 845. If the application server 170 determines not to update the paging cycle for the given UE at 845 (e.g., the current paging cycle is deemed appropriate, etc.), then no paging cycle adjustment is initiated by the application server 170. Otherwise, if the application server 170 determines to update the paging cycle for the given UE at 845, the application server 170 transmits another request to the RAN-core network for the given UE's paging cycle to be updated to the new paging cycle, 850. The RAN-core network receives the paging cycle request of 850 and the RAN-core network assigns the requested, updated paging cycle to the given UE, 855, after which the given UE periodically wakes up and monitors the downlink paging channel for pages from the RAN-core network in accordance with the new paging cycle, 860.

While FIG. 8 focuses upon an implementation whereby the application server 170 implements paging cycle changes via direct interaction or negotiation with the RAN-core network as shown at 825 or 850, in an alternative implementation, the application server 170 can instead send one or more messages to the given UE to prompt the given UE itself to initiate the paging cycle changes. In this case, the application server 170 would not directly ask the RAN-core network to change the given UE's paging cycle, but would instead ask the given UE to ask the RAN-core network to change the given UE's paging cycle. Examples of how UEs can request changes to their paging cycles have already been described above with respect to FIG. 6, and this alternative implementation leverages this type of UE-initiated paging cycle adjustment with a server-based trigger.

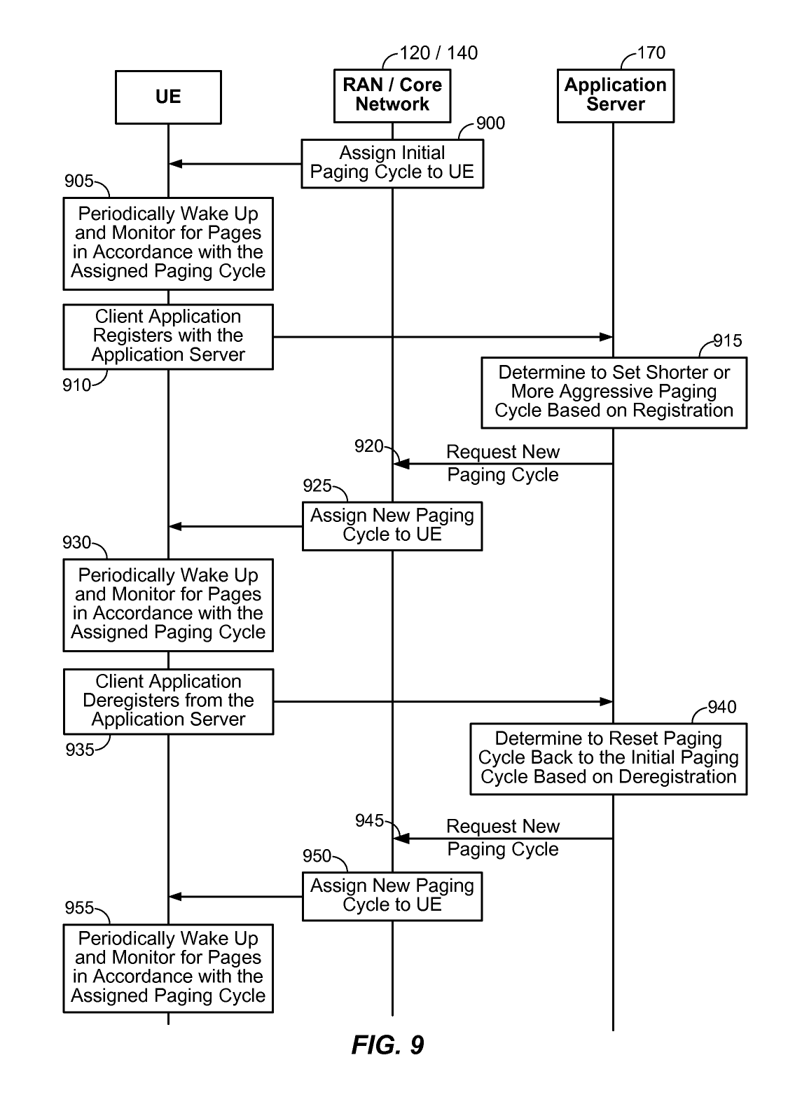

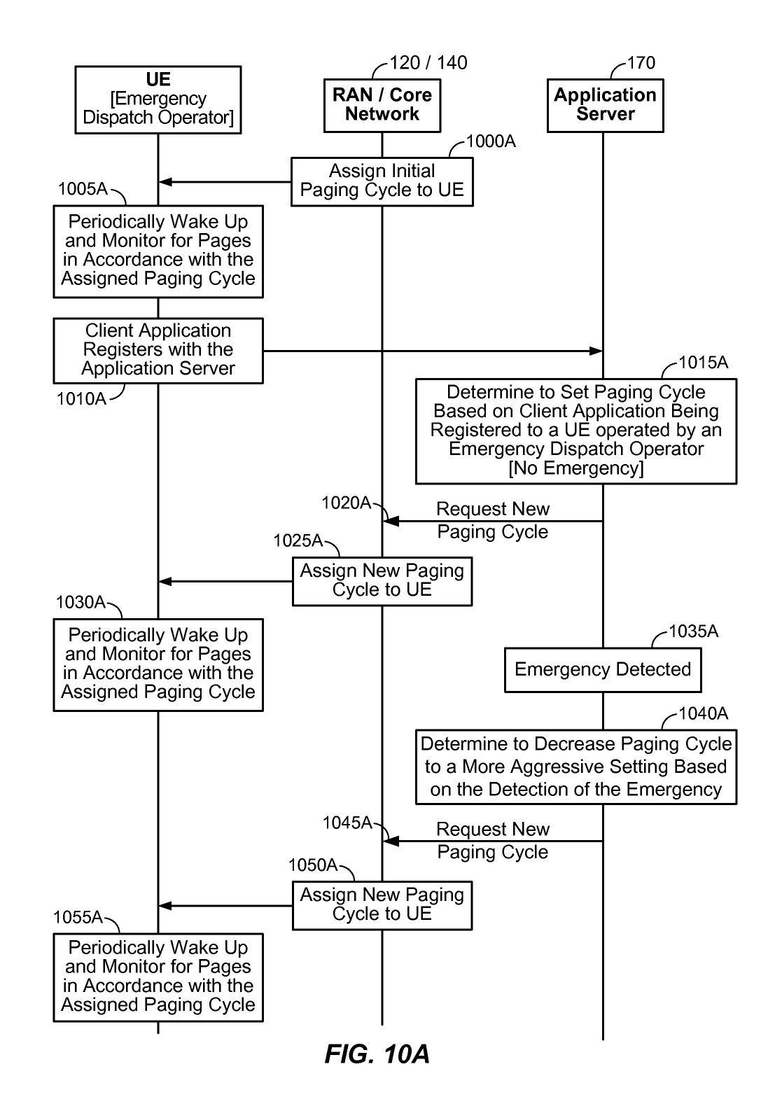

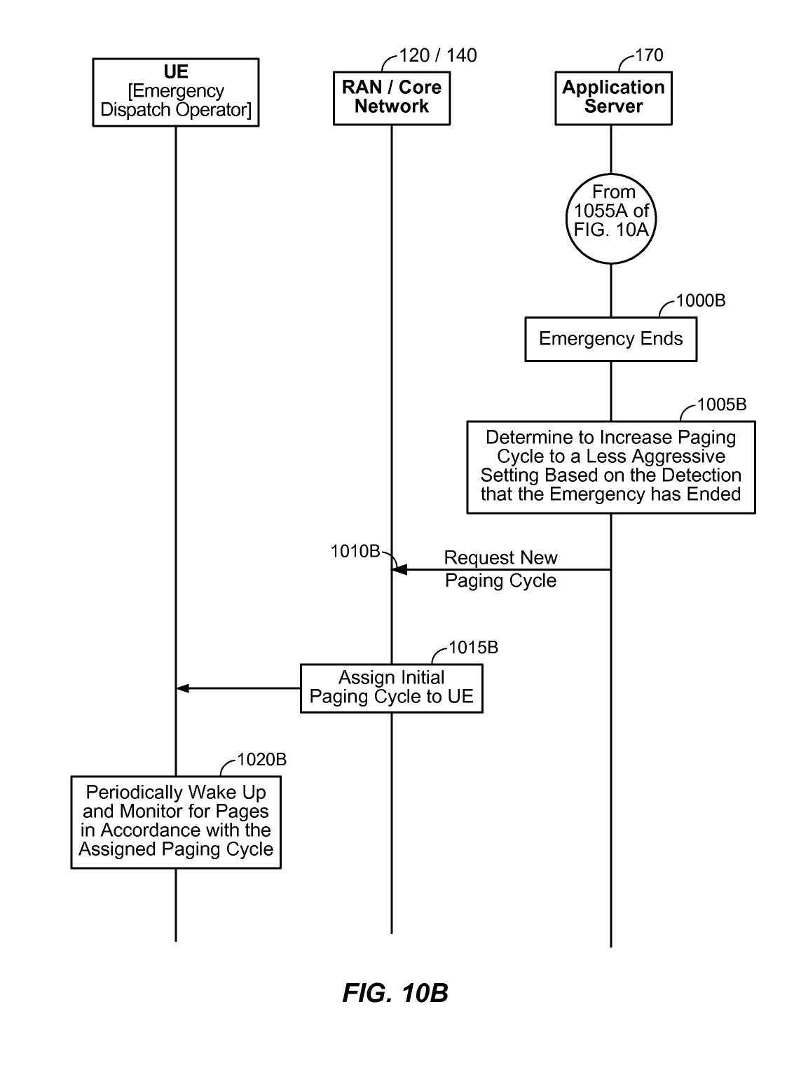

As discussed above with respect to Table 2 and 815-820 of FIG. 8, there are many different triggering conditions that can prompt the application server 170 to initiate either shorten or lengthen (or leave alone) the paging cycle used by the given UE. FIGS. 9-10B illustrate two of these detailed use cases pertaining to server-initiated paging cycle adjustments in more detail. In particular, FIG. 9 and FIGS. 10A-10B illustrate two example implementations of the process of FIG. 8 based on different decision logic implemented at the application server 170 during 815-820 and/or 840-845 of FIG. 8.

Referring to FIG. 9, 900-910 correspond to 800-810 and will thereby not be discussed further for the sake of brevity. At 915, the application server 170 determines to set a shorter or more aggressive paging cycle for the given UE based solely upon the given client application's registration. Thus, in FIG. 9, the mere status of the given client application as being registered is sufficient for the application server 170 to decide to decrease the given UE's paging cycle. In an example, the given client application in FIG. 9 may be exclusively reserved for emergency responders, or for emergency or delay-sensitive communication sessions. As will be appreciated, 915 corresponds to an example implementation of 815-820 of FIG. 8. After the decision of 915, 920-930 correspond to 825-835 of FIG. 8 and will thereby not be discussed further for the sake of brevity.

Referring to FIG. 9, at some later point in time, the given client application deregisters itself from the application server 170, 935. While the deregistration is shown at 935 of FIG. 9 as involving an express communication from the given UE to the application server 170, the deregistration of 935 can also be a passive operation implemented at the application server 170 based on inactivity in another embodiment. At 940, based on the deregistration of the given client application, the application server 170 determines to reset the paging cycle from the shorter or more aggressive paging cycle decided at 915 to the previous paging cycle from 900. As will be appreciated, 940 corresponds to an example implementation of 840-845 of FIG. 8. After the decision of 940, 945-955 correspond to 850-860 of FIG. 8 and will thereby not be discussed further for the sake of brevity.

Referring to FIG. 10A, 1000A-1010A correspond to 800-810 and will thereby not be discussed further for the sake of brevity. At 1015A, the application server 170 determines to set a shorter or more aggressive paging cycle for the given UE based upon the given UE being operated by an emergency responder associated with an emergency dispatch service. In the embodiment of FIGS. 10A-10B, different paging cycles can be associated with different degrees of emergency. The different degrees can simply be ‘emergency’ or ‘no emergency’, or alternatively the emergencies can be tiered based on severity. Generally, the more severe the emergency, the shorter the corresponding paging cycle. Also, the emergency degree that the application server 170 associates with the given UE can be based on proximity between the given UE and emergency. Thus, an emergency in California may not trigger a change in the paging cycle used by a UE operated by an emergency responder in New Jersey. As will be appreciated, if proximity is a factor to the decision logic of 1015A, the application server 170 can acquire the given UE's location either from the given UE itself or from the RAN-core network.

At 1015A, assume that the given UE is not associated with a current emergency (e.g., because the given UE is not in proximity to an emergency response zone, etc.). Under this assumption, at 1015A, the application server 170 can determine to assign a paging cycle that is shorter than a paging cycle used by non-emergency personnel but longer than a paging cycle used by emergency personnel associated with active emergencies. As will be appreciated, 1015A corresponds to an example implementation of 815-820 of FIG. 8. After the decision of 1015A, 10120A-1030A correspond to 825-835 of FIG. 8 and will thereby not be discussed further for the sake of brevity.

Referring to FIG. 10A, at some later point in time, the application server 170 detects an emergency in association with the given UE, 1035A. The detection of 1035A can occur in any number of ways (e.g., the given UE moves into an emergency response zone, a new emergency is detected in proximity to the given UE, etc.). At 1040A, based on the detection of the emergency at 1035A, the application server 170 determines to decrease the paging cycle of the given UE to a more aggressive setting. As will be appreciated, 1040A corresponds to an example implementation of 840-845 of FIG. 8. After the decision of 1040A, 1045A-1055A correspond to 850-860 of FIG. 8 and will thereby not be discussed further for the sake of brevity.

Turning to FIG. 10B, at some later point in time, the application server 170 detects either that the emergency that was initially detected at 1035A of FIG. 10A has ended or at least is no longer relevant to the given UE (e.g., the given UE has gone off-duty, the given UE has left the emergency response zone, etc.), 1000B. At 1005B, based on the detection of the emergency cessation at 1000B, the application server 170 determines to increase the paging cycle of the given UE to a less aggressive setting. As will be appreciated, 1005B corresponds to another example implementation of 840-845 of FIG. 8. After the decision of 1000B, 1010B-1020B correspond to 850-860 of FIG. 8 and will thereby not be discussed further for the sake of brevity. While not shown explicitly in FIG. 10B, if the emergency instead had simply changed degree or severity level instead of ending altogether, the paging cycle for the given UE may be updated accordingly (e.g., to a shorter paging cycle than the case where the emergency ends outright).

As will be appreciated, once any paging cycle is established as shown in FIGS. 8-10B, the application server 170 can determine to initiate a communication session (e.g., a delay-sensitive communication session), and send an announce message to the RAN-core network for transmission to the target UE for announcing the communication session. If at this point the target UE has been assigned a short or more aggressive paging cycle, it will be appreciated that the announce message will generally be received by the target UE more quickly than if a longer or less aggressive paging cycle were being used.

While the embodiments above have been described primarily with reference to 1x EV-DO architecture in CDMA2000 networks, GPRS architecture in W-CDMA or UMTS networks and/or EPS architecture in LTE-based networks, it will be appreciated that other embodiments can be directed to other types of network architectures and/or protocols.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of operating a server that is configured to arbitrate delay-sensitive communication sessions and is independent of a network component that serves a given user equipment (UE) and is configured to assign a paging cycle used by the given UE, comprising:
registering, by the server, a client application installed on the given UE;
evaluating one or more paging cycle criteria for the registered client application;
determining to establish a target paging cycle used for downlink paging of the given UE by a serving network based on the evaluation; and
transmitting, by the server to the network component, a request for the network component to transition the given UE to the target paging cycle based on the determination.

2. The method of claim 1, further comprising:
determining to announce a given delay-sensitive communication session to the given UE; and
transmitting an announce message for announcing the given delay-sensitive communication session to the serving network of the given UE for transmission based on the target paging cycle.

3. The method of claim 1, further comprising:
obtaining an indication of a current paging cycle assigned to the given UE,
wherein the determination is based on the current paging cycle failing to satisfy the one or more paging cycle criteria.

4. The method of claim 3, wherein the indication of the current paging cycle is obtained from the given UE.

5. The method of claim 4, wherein the indication of the current paging cycle is obtained from the given UE in conjunction with the registration.

6. The method of claim 4, wherein the indication of the current paging cycle is obtained from the given UE in response to a paging cycle query issued by the server to the given UE.

7. The method of claim 3, wherein the indication of the current paging cycle is obtained from the network component.

8. The method of claim 7, wherein the indication of the current paging cycle is obtained from the network component in response to a paging cycle query issued by the server to the network component.

9. The method of claim 1, wherein the network component is a component of an access network portion of the serving network and/or a core network portion of the serving network.

10. The method of claim 1,
wherein the determination includes calculating the target paging cycle without knowledge of a current paging cycle assigned to the given UE, and
wherein the transmitting transmit the request for the network component to transition the given UE to the target paging cycle irrespective of whether the current paging cycle is already equal to the target paging cycle.

11. The method of claim 1, further comprising:
determining to modify the target paging cycle; and
transmitting, by the server to the network component, a supplemental request for the network component to transition the given UE to the modified paging cycle based on the modify determination.

12. The method of claim 1, wherein the one or more paging cycle criteria evaluated by the server include (i) a device type of the given UE, (ii) a battery level of the given UE, (iii) a priority of a user of the given UE, (iv) a group to which the user of the given UE is a member, (v) system load, (vi) whether an emergency is occurring, (vii) whether a call history associated with either the user or the given UE indicates a lower or higher likelihood of delay-sensitive communication sessions targeted to the given UE, (viii) whether the registered client application is associated with one-to-one or group communication sessions, (ix) whether the user the given UE is expected to receive a call based on a known calendar entry or schedule of the user or another user, (x) whether the registered client application completes its registration with the server, (xi) whether a Do Not Disturb feature is activated for the given UE, (xii) a radio access technology (RAT) of a serving access network or a serving core network of the given UE or (xiii) any combination thereof.

13. The method of claim 12,
wherein the one or more paging cycle criteria evaluated by the server include the device type of the UE,
wherein the device type of the given UE indicates whether the given UE is associated with a weak battery expectation, and
wherein the target paging cycle is set to a first duration that is expected to be longer than a current paging cycle used by the given UE if the device type of the given UE is associated with the weak battery expectation, or
wherein the target paging cycle is set to a second duration that is expected to be equal to or shorter than the current paging cycle used by the given UE if the device type of the given UE is not associated with the weak battery expectation.

14. The method of claim 12,
wherein the one or more paging cycle criteria evaluated by the server include the battery level of the given UE,
wherein the target paging cycle is set to a first duration that is expected to be longer than a current paging cycle used by the given UE if the battery level of the given UE is below a threshold, or
wherein the target paging cycle is set to a second duration that is expected to be equal to or shorter than the current paging cycle used by the given UE if the battery level of the given UE is not below the threshold.

15. The method of claim 12,
wherein the one or more paging cycle criteria evaluated by the server include the priority of the user or the group and the system load,
wherein the target paging cycle is set to a first duration that is expected to be longer than a current paging cycle used by the given UE if the priority of the user or the group is below a first threshold and the system load is above a second threshold,
wherein the target paging cycle is set to a second duration that is expected to be equal to or shorter than the current paging cycle used by the given UE if the priority of the user or the group is not below the first threshold and/or the system load is not above the second threshold.

16. The method of claim 12,
wherein the one or more paging cycle criteria evaluated by the server include whether the emergency is occurring,
wherein the target paging cycle is set to a first duration that is expected to be shorter than a current paging cycle used by the given UE if the given UE is associated with an emergency dispatch service and the emergency is detected,
wherein the target paging cycle is set to a second duration that is expected to be equal to or shorter than the current paging cycle used by the given UE if the given UE is not associated with the emergency dispatch service or the emergency is not detected.

17. The method of claim 16, wherein the first duration is set based on a degree or severity of the emergency and/or a proximity between the given UE and the emergency.

18. The method of claim 16, further comprising:
detecting that the emergency has ended, and
transmitting, by the server to the network component, a message that permits the network component to transition the given UE back to a previous paging cycle.

19. The method of claim 12,
wherein the one or more paging cycle criteria evaluated by the server include the call history association and the battery level of the given UE,
wherein the target paging cycle is set to a first duration that is expected to be shorter than a current paging cycle used by the given UE if the call history indicates the higher likelihood and the battery level is not below a threshold, and
wherein the target paging cycle is set to a second duration that is expected to be equal to or shorter than the current paging cycle used by the given UE if the call history indicates the lower likelihood and/or the battery level is below the threshold.

20. The method of claim 12,
wherein the one or more paging cycle criteria evaluated by the server include whether the user the given UE is expected to receive the call,
wherein the target paging cycle is set to a first duration that is expected to be shorter than a current paging cycle used by the given UE if the given UE is expected to receive the call, or
wherein the target paging cycle is set to a second duration that is expected to be equal to or shorter than the current paging cycle used by the given UE if the given UE is not expected to receive the call.

21. The method of claim 12,
wherein the one or more paging cycle criteria evaluated by the server include whether the registered client application completes its registration with the server,
wherein the target paging cycle is set to a duration that is expected to be shorter than a current paging cycle used by the given UE based on the completion of the registration with the server.

22. The method of claim 21, further comprising:
detecting de-registration of the given UE from the server, and
transmitting, by the server to the network component, a message that permits the network component to transition the given UE back to a previous paging cycle.

23. The method of claim 12,
wherein the one or more paging cycle criteria evaluated by the server include whether the registered client application is associated with one-to-one or group communication sessions,
wherein the target paging cycle is set to a first duration that is expected to be shorter than a current paging cycle used by the given UE if the given UE belongs to a communication group that engages in frequent session and/or high-priority sessions,
wherein the target paging cycle is set to a second duration that is expected to be equal to or shorter than the current paging cycle used by the given UE if the given UE does not belong to the communication group that engages in frequent session and/or high-priority sessions.

24. The method of claim 12,
wherein the one or more paging cycle criteria evaluated by the server include whether the Do Not Disturb feature is activated for the given UE,
wherein the target paging cycle is set to a first duration that is expected to be longer than a current paging cycle used by the given UE if the Do Not Disturb feature is activated,
wherein the target paging cycle is set to a second duration that is expected to be equal to or shorter than the current paging cycle used by the given UE if the Do Not Disturb feature is not activated for the given UE.

25. The method of claim 12,
wherein the one or more paging cycle criteria evaluated by the server include whether the RAT of the serving access network of the given UE or the serving core network of the given UE,
wherein the target paging cycle is set to different durations based on whether the RAT is Universal Mobile Telecommunications System (UMTS), Long Term Evolution (LTE) or WiFi.

26. A method of operating a network component that serves a given user equipment (UE) and is configured to assign a paging cycle used by the given UE, the network component being independent of a server configured to arbitrate delay-sensitive communication sessions, comprising:
assigning a first paging cycle to the given UE;
receiving, at the network component from the server, a request for the network component to transition the given UE to a second paging cycle that is different from the first paging cycle; and
assigning the second paging cycle to the given in accordance with the received request.

27. The method of claim 26, further comprising:
receiving, at the network component from the server, an announce message for announcing a given delay-sensitive communication session of the given UE; and
transmitting the announce message to the given UE based on the target paging cycle.

28. The method of claim 26, further comprising:
reporting, to the server, an indication of a current paging cycle assigned to the given UE,
wherein the request is received in response to the reporting of the indication.

29. The method of claim 26, further comprising:
receiving, at the network component from the server, a request for the network component to transition the given UE to a third paging cycle that is different from the second paging cycle; and
assigning the third paging cycle to the given in accordance with the received supplemental request.

30. The method of claim 29,
wherein the third paging cycle is equal to the first paging cycle, or
wherein the third paging cycle is not equal to the first paging cycle.

31. The method of claim 26, wherein the network component is a component of an access network portion of a serving network of the given UE and/or a core network portion of the serving network of the given UE.

32. A server that is configured to arbitrate delay-sensitive communication sessions and is independent of a network component that serves a given user equipment (UE) and is configured to assign a paging cycle used by the given UE, comprising:
means for registering a client application installed on the given UE;
means for evaluating one or more paging cycle criteria for the registered client application;
means for determining to establish a target paging cycle used for downlink paging of the given UE by a serving network based on the evaluation; and
means for transmitting, to the network component, a request for the network component to transition the given UE to the target paging cycle based on the determination.

33. The server of claim 32, wherein the one or more paging cycle criteria evaluated by the server include (i) a device type of the given UE, (ii) a battery level of the given UE, (iii) a priority of a user of the given UE, (iv) a group to which the user of the given UE is a member, (v) system load, (vi) whether an emergency is occurring, (vii) whether a call history associated with either the user or the given UE indicates a lower or higher likelihood of delay-sensitive communication sessions targeted to the given UE, (viii) whether the registered client application is associated with one-to-one or group communication sessions, (ix) whether the user the given UE is expected to receive a call based on a known calendar entry or schedule of the user or another user, (x) whether the registered client application completes its registration with the server, (xi) whether a Do Not Disturb feature is activated for the given UE, (xii) a radio access technology (RAT) of a serving access network or a serving core network of the given UE or (xiii) any combination thereof.

34. A network component that serves a given user equipment (UE) and is configured to assign a paging cycle used by the given UE, the network component being independent of a server configured to arbitrate delay-sensitive communication sessions, comprising:
means for assigning a first paging cycle to the given UE;
means for receiving, component from the server, a request for the network component to transition the given UE to a second paging cycle that is different from the first paging cycle; and
means for assigning the second paging cycle to the given in accordance with the received request.

35. The network component of claim 34, wherein the network component is a component of an access network portion of a serving network of the given UE and/or a core network portion of the serving network of the given UE.

36. A server that is configured to arbitrate delay-sensitive communication sessions and is independent of a network component that serves a given user equipment (UE) and is configured to assign a paging cycle used by the given UE, comprising:
logic configured to register a client application installed on the given UE;
logic configured to evaluate one or more paging cycle criteria for the registered client application;
logic configured to determine to establish a target paging cycle used for downlink paging of the given UE by a serving network based on the evaluation; and
logic configured to transmit, to the network component, a request for the network component to transition the given UE to the target paging cycle based on the determination.

37. The server of claim 36, wherein the one or more paging cycle criteria evaluated by the server include (i) a device type of the given UE, (ii) a battery level of the given UE, (iii) a priority of a user of the given UE, (iv) a group to which the user of the given UE is a member, (v) system load, (vi) whether an emergency is occurring, (vii) whether a call history associated with either the user or the given UE indicates a lower or higher likelihood of delay-sensitive communication sessions targeted to the given UE, (viii) whether the registered client application is associated with one-to-one or group communication sessions, (ix) whether the user the given UE is expected to receive a call based on a known calendar entry or schedule of the user or another user, (x) whether the registered client application completes its registration with the server, (xi) whether a Do Not Disturb feature is activated for the given UE, (xii) a radio access technology (RAT) of a serving access network or a serving core network of the given UE or (xiii) any combination thereof.

38. A network component that serves a given user equipment (UE) and is configured to assign a paging cycle used by the given UE, the network component being independent of a server configured to arbitrate delay-sensitive communication sessions, comprising:
logic configured to assign a first paging cycle to the given UE;
logic configured to receive, component from the server, a request for the network component to transition the given UE to a second paging cycle that is different from the first paging cycle; and
logic configured to assign the second paging cycle to the given in accordance with the received request.

39. The network component of claim 38, wherein the network component is a component of an access network portion of a serving network of the given UE and/or a core network portion of the serving network of the given UE.

40. A non-transitory computer-readable medium containing instructions stored thereon, which, when executed by a server that is configured to arbitrate delay-sensitive communication sessions and is independent of a network component that serves a given user equipment (UE) and is configured to assign a paging cycle used by the given UE, cause the server to perform operations, the instructions comprising:
at least one instruction configured to cause the server to register a client application installed on the given UE;
at least one instruction configured to cause the server to evaluate one or more paging cycle criteria for the registered client application;
at least one instruction configured to cause the server to determine to establish a target paging cycle used for downlink paging of the given UE by a serving network based on the evaluation; and
at least one instruction configured to cause the server to transmit, to the network component, a request for the network component to transition the given UE to the target paging cycle based on the determination.

41. The non-transitory computer-readable medium of claim 40, wherein the one or more paging cycle criteria evaluated by the server include (i) a device type of the given UE, (ii) a battery level of the given UE, (iii) a priority of a user of the given UE, (iv) a group to which the user of the given UE is a member, (v) system load, (vi) whether an emergency is occurring, (vii) whether a call history associated with either the user or the given UE indicates a lower or higher likelihood of delay-sensitive communication sessions targeted to the given UE, (viii) whether the registered client application is associated with one-to-one or group communication sessions, (ix) whether the user the given UE is expected to receive a call based on a known calendar entry or schedule of the user or another user, (x) whether the registered client application completes its registration with the server, (xi) whether a Do Not Disturb feature is activated for the given UE, (xii) a radio access technology (RAT) of a serving access network or a serving core network of the given UE or (xiii) any combination thereof.

42. A non-transitory computer-readable medium containing instructions stored thereon, which, when executed by a network component that serves a given user equipment (UE) and is configured to assign a paging cycle used by the given UE, the network component being independent of a server configured to arbitrate delay-sensitive communication sessions, cause the network component to perform operations, the instructions comprising:
at least one instruction configured to cause the network component to assign a first paging cycle to the given UE;
at least one instruction configured to cause the network component to receive, component from the server, a request for the network component to transition the given UE to a second paging cycle that is different from the first paging cycle; and
at least one instruction configured to cause the network component to assign the second paging cycle to the given in accordance with the received request.

43. The non-transitory computer-readable medium of claim 42, wherein the network component is a component of an access network portion of a serving network of the given UE and/or a core network portion of the serving network of the given UE.
